(19) United States
(12) Patent Application Publication
(10) Pub. No.: US 2016/0350550 A1
(43) Pub. Date: Dec. 1, 2016

(54) DATA BLACKHOLE PROCESSING METHOD

(71) Applicant: ANTAIOS (BEIJING) INFORMATION TECHNOLOLOGY CO., LTD., Beijing (CN)

(72) Inventor: Jiaxiang WANG, Beijing (CN)

(73) Assignee: Antaios (Beijing) Information Technology Co., Ltd., Beijing (CN)

(21) Appl. No.: 15/116,181

(22) PCT Filed: Mar. 3, 2015
(86) PCT No.: PCT/CN2015/073557

§ 371 Date: Aug. 2, 2016

(30) Foreign Application Priority Data
Mar. 4, 2014 (CN) 201410076646.8

(51) Int. Cl. G06F 21/62; G06F 21/55; G06F 21/60

(52) U.S. Cl. CPC G06F 21/6218; G06F 21/604; G06F 21/556

(57) ABSTRACT

A data blackhole processing method, comprising: a computing device deploying a data blackhole system, causing the computing device to become a data blackhole terminal; a data blackhole system being taken to mean a system where process data and operation results of the process of operation of the computing device are stored in a specific storage location to ensure normal operation of the computing device; establishing a data blackhole space, comprising a data storage area, for which the storage location is open, on a computing device and/or on a network; establishing a correspondence between the user of the computing device and the data blackhole space or a portion of the data blackhole space; redirecting to the data blackhole space corresponding to the user the data generated by the user when operating the data blackhole terminal; preventing a data persistence operation from being performed on the local storage device, and preventing output of the data to a local port by means of a non-data blackhole terminal. Thus it is ensured that data that has enter the data blackhole terminal or data blackhole space is present only in the data blackhole space.

### CROSS-REFERENCE TO RELATED APPLICATIONS

This application is the national phase of International Application No. PCT/CN2015/073557, filed on Mar. 3, 2015, which claims the benefit of priority to the Chinese Patent Application No. 201410076646.8, filed on Mar. 4, 2014, the entire disclosure of which is incorporated herein by reference.

### TECHNICAL FIELD

The present disclosure generally relates to a computer security field, and more particularly, to a data black hole processing method.

### BACKGROUND

Conventionally, a field of electronic information security includes three sub-fields that are system security, data security and device security.

In the sub-field of data security, three types of technology are usually implemented for ensuring data security:

(1) data content security technology including a data encryption/decryption technology and a port to port data encryption technology to ensure no illegal access to data content during the data is being stored and transmitted;

(2) data security migration technology including prevention of illegal duplication, print or other forms of output to ensure data security during the data is in use and being migrated;

(3) network blocking technology including cutting off a network physically and setting a network shield.

According to relevant analysis, currently, at most 50% of total harms to a computer can be effectively detected. The aforementioned technologies are not fully capable of dealing with computer kernel viruses, Trojan viruses, operating system vulnerabilities, system backdoors and man-made secret divulgements. In fact, malicious codes exist in any computing devices (including computers, laptops, handheld communication devices, etc.).

Once a piece of malicious code invades a terminal system, the encryption technology, the illegal duplication prevention technology and the network cut-off technology become ineffective. Current hacking technologies can take advantage of the system vulnerabilities or the system backdoors to break through the aforementioned security technologies and embed a piece of malicious code, so as to acquire user data using the piece of malicious code. Further, the aforementioned security technologies are also incapable of preventing an active or passive secret divulgement by a confidential staff. For an example, an internal staff can use a storage device to download needed information from an internal network or a terminal, and then take the storage device away resulting in an internal divulgement. For another example, an internal staff can directly take a computing device away.

Therefore, the illegal duplication prevention technology fails to ensure that confidential information cannot be illegally stored in a terminal. Moreover, it is impossible to ensure that no confidential information is missed based on network filtering technology. A secret divulgement may take place when a confidential staff takes advantage of malicious codes or tools or when a confidential device or storage medium malfunctions.

### SUMMARY

Embodiments of the present disclosure provide a data black hole processing method, which can improve data security.

In an embodiment, a data black hole processing method is provided, which includes: configuring a data black hole system in a computing device so as to form a data black hole terminal, where the data black hole system can store intermediate data and an operation result generated during operation of the computing device in a specific storage location, and ensure that the computing device runs normally; establishing a data black hole space, where the data black hole space includes a data storage partition established at a storage location on a network, where the data storage partition is adapted to be visited by the data black hole system but not by an operating system or software of an application layer; establishing a corresponding relationship between a user using the computing device and the data black hole space or a part of the data black hole space; re-directing a data writing operation generated by a user's operation at the data black hole terminal to the data black hole space corresponding to the user; blocking a data persistence operation to a local storage device; and blocking data output through a local port except for data output to the data black hole terminal so as to ensure data entering the data black hole terminal or the data black hole space only exists in the data black hole space.

In some embodiments, configuring the data black hole system includes configuring a data security storage method, which is adapted to re-direct a data writing operation generated by an operation of a user at the data black hole terminal to a data black hole space corresponding to the user, where the data security storage method includes: receiving a first hardware instruction; if the first hardware instruction is a storage instruction, changing a destination address in the storage instruction to an address in the data black hole space corresponding to the user; and sending the changed storage instruction to a hardware layer for execution.

In some embodiments, configuring the data black hole system includes configuring a data security reading method, which includes: receiving a second hardware instruction; if the second hardware instruction is a reading instruction and data to be read by the reading instruction has been stored in the data black hole space, changing a source address in the reading instruction to an address in the data black hole space corresponding to the user; and sending the changed reading instruction to the hardware layer for execution.

In some embodiments, configuring the data black hole system includes configuring a data security reading method, which includes: receiving a second hardware instruction; if the second hardware instruction is a reading instruction and data to be read by the reading instruction has been stored in the data black hole space, providing the user a choice between reading data in a local storage device or in the data black hole space; reading the data in the local storage device or in the data black hole space based on the user's choice; and sending the changed reading instruction to the hardware layer for execution.

In some embodiments, reading the data in the data black hole space includes: changing a source address in the reading instruction to an address in the data black hole space corresponding to the user.

In some embodiments, receiving the hardware instruction includes: receiving the first and second hardware instruction from a hardware abstract layer.

In some embodiments, configuring the data black hole system includes configuring a data security storage method, which is adapted to re-direct a data writing operation generated by an operation of a user at the data black hole terminal to a data black hole space corresponding to the user, where the data security storage method includes: buffering a first instruction runtime environment, where the first instruction runtime environment includes an address register, which is adapted to store an address of a next machine instruction to be executed, where the address of the next machine instruction to be executed is a first address; acquiring a machine instruction segment to be dispatched, where a last instruction in the machine instruction segment to be dispatched is a first program transfer instruction; analyzing each instruction in the machine instruction segment to be dispatched and, if there is a storage instruction in the machine instruction segment, changing a destination address in the storage instruction to an address in the data black hole space corresponding to the user; inserting, before the first program transfer instruction, a second program transfer instruction so as to form an instruction reconstruction segment with a second address, where the second program transfer instruction points to an entrance address of an instruction reconstruction platform; changing the first address stored in the address register to the second address; and restoring the first instruction runtime environment.

In some embodiments, configuring the data black hole system includes configuring a data security storage method, which is adapted to re-direct a data writing operation generated by an operation of a user at the data black hole terminal to a data black hole space corresponding to the user, where the data security storage method includes: buffering a first instruction runtime environment; reading a destination address from a first storage location and acquiring a machine instruction segment to be dispatched based on the destination address, where a last instruction in the machine instruction segment to be dispatched is a first program transfer instruction; storing a destination address of the first program transfer instruction in the first storage location; analyzing each instruction in the machine instruction segment to be dispatched and, if there is a storage instruction in the machine instruction segment, changing a destination address in the storage instruction to a corresponding storage address in the data black hole space; replacing the first program transfer instruction with a second program transfer instruction so as to form an instruction reconstruction segment with a second address, where the second program transfer instruction points to an entrance address of an instruction reconstruction platform; and restoring the first instruction runtime environment and jumping to the second address for further operation.

In some embodiments, configuring the data black hole system includes configuring a data security storage method, which is adapted to re-direct a data writing operation generated by an operation of a user at the data black hole terminal to a data black hole space corresponding to the user, where the data security storage method includes: buffering a first instruction runtime environment; acquiring an address and a parameter of a program transfer instruction stored in a stack; computing an address of a next instruction to be executed, where the address of the next instruction to be executed is a first address; acquiring a machine instruction segment to be dispatched based on the first address, where a last instruction in the machine instruction segment to be dispatched is a first program transfer instruction; analyzing each instruction in the machine instruction segment to be dispatched and, if there is a storage instruction in the machine instruction segment, changing a destination address in the storage instruction to a corresponding storage address in the data black hole space; replacing the first program transfer instruction with a push instruction, where an address and a parameter of the first program transfer instruction are recorded in the push instruction; adding a second program transfer instruction after the push instruction so as to form an instruction reconstruction segment with a second address, where the second program transfer instruction points to an entrance address of an instruction reconstruction platform; and restoring the first instruction runtime environment and jumping to the second address for further operation.

In some embodiments, configuring the data black hole system includes configuring a data security reading method, which includes: buffering a second instruction runtime environment, where the second instruction runtime environment includes an address register, which is adapted to store an address of a next machine instruction to be executed, where the address of the next machine instruction to be executed is the first address; acquiring a machine instruction segment to be dispatched, where a last instruction in the machine instruction segment to be dispatched is the first program transfer instruction; analyzing each instruction in the machine instruction segment to be dispatched and, if there is a reading hardware instruction in the machine instruction segment and data to be read by the reading instruction has been stored in the data black hole space, changing a source address in the reading instruction to a corresponding storage address in the data black hole space; inserting, before the first program transfer instruction, the second program transfer instruction so as to form an instruction reconstruction segment with the second address, where the second program transfer instruction points to an entrance address of an instruction reconstruction platform; changing the first address stored in the address register to the second address; and restoring the second instruction runtime environment.

In some embodiments, configuring the data black hole system includes configuring a data security reading method, which includes: buffering a second instruction runtime environment; reading a destination address from the first storage location and acquiring a machine instruction segment to be dispatched based on the destination address, where a last instruction in the machine instruction segment to be dispatched is the first program transfer instruction; storing a destination address of the first program transfer instruction in the first storage location; analyzing each instruction in the machine instruction segment to be dispatched and, if there is a reading instruction in the machine instruction segment and data to be read by the reading instruction has been stored in the data black hole space, changing a source address in the reading instruction to a corresponding storage address in the data black hole space; replacing the first program transfer instruction with the second program transfer instruction so as to form an instruction reconstruction segment with the second address, where the second program transfer instruction points to an entrance address of an instruction reconstruction platform; and restoring the second instruction runtime environment and jumping to the second address for further operation.

In some embodiments, configuring the data black hole system includes configuring a data security reading method, which includes: buffering a second instruction runtime environment; acquiring an address and a parameter of a program transfer instruction stored in a stack; computing an address of a next instruction to be executed, where the address of the next instruction to be executed is the first address; acquiring a machine instruction segment to be dispatched based on the first address, where a last instruction in the machine instruction segment to be dispatched is the first program transfer instruction; analyzing each instruction in the machine instruction segment to be dispatched and, if there is a reading instruction in the machine instruction segment and data to be read by the reading instruction has been stored in the data black hole space, changing a source address in the reading instruction to a corresponding storage address in the data black hole space; replacing the first program transfer instruction with a push instruction, where an address and a parameter of the first program transfer instruction are recorded in the push instruction; adding the second program transfer instruction after the push instruction so as to form an instruction reconstruction segment with the second address, where the second program transfer instruction points to an entrance address of an instruction reconstruction platform; and restoring the second instruction runtime environment and jumping to the second address for further operation.

In some embodiments, the data persistence operation includes a data writing operation.

In some embodiments, acquiring the machine instruction segment to be dispatched includes: reading an address of a machine instruction to be dispatched from the address register; for finding a program transfer instruction, retrieving the machine instruction to which the address of the machine instruction points and other instructions following the machine instruction till first found of a program transfer instruction, which is called the first program transfer instruction, where the first program transfer instruction is adapted to change an order for executing machine instructions; and forming the machine instruction segment to be dispatched including the first program transfer instruction and all machine instructions to be dispatched before the first program transfer instruction.

In some embodiments, acquiring the machine instruction segment to be dispatched includes: reading an address of a machine instruction to be dispatched from the address register; for finding a program transfer instruction, retrieving the machine instruction to which the address of the machine instruction points and other instructions following the machine instruction till a first program transfer instruction with a parameter address is found, which is called the first program transfer instruction, where the first program transfer instruction is adapted to change an order for executing machine instructions; and forming the machine instruction segment to be dispatched including the first program transfer instruction and all machine instructions to be dispatched before the first program transfer instruction.

Compared with a conventional art, the data black hole processing method improves data security. By employing an embodiment of the present disclosure, the black hole space corresponds to a user. When a hacker duplicates, dumps, transmits and intercepts data posterior to acquiring data authority using malicious codes such as the system vulnerability, the system backdoor, the Trojan virus, etc., all data being transmitted to an external device, an external port, an external user and an external terminal, is re-directed to the data black hole space (namely, the black hole space corresponding to the user), and the transmission may be completed inside the data black hole space (namely, the black hole space corresponding to the user). Accordingly, all operations such as stealing data, intercepting data, transmitting data, etc., may be completed inside the data black hole space. Therefore, if a confidential staff (namely, a staff having the data authority) is trying to preserve, duplicate, transmit or output data without permission, all data processing operations may be completed inside the data hole space (namely, the black hole space corresponding to the user), so that no divulgement will happen because of malicious manipulation.

### BRIEF DESCRIPTION OF THE DRAWINGS

FIG. 1 schematically illustrates a system hierarchy diagram for a computing device in a conventional technology;

FIG. 2 illustrates a flow diagram for a method for reconstructing an instruction in run time according to an embodiment in the present disclosure;

FIG. 3 schematically illustrates a diagram for a procedure for forming an instruction reconstruction segment according to an embodiment in the present disclosure;

FIG. 4 illustrates a flow diagram for the step S102 as shown in FIG. 2 according to another embodiment in the present disclosure;

FIG. 5 illustrates a flow diagram for a method for reconstructing an instruction in run time according to another embodiment in the present disclosure, where an instruction reconstruction segment is stored using an address corresponding table;

FIG. 6 illustrates a flow diagram for a method for reconstructing an instruction in run time according to another embodiment in the present disclosure, where a destination address of a first program transfer instruction is stored in a storage location established independently;

FIG. 7 illustrates a flow diagram for a method for reconstructing an instruction in run time according to another embodiment in the present disclosure, where disassembly and assembly are performed to an instruction with flexible length;

FIG. 8 illustrates a flow diagram for a method for reconstructing an instruction in run time according to another embodiment in the present disclosure, where the first program transfer instruction is replaced or recorded by a push instruction;

FIG. 9a illustrates a flow diagram for a method for reconstructing an instruction in run time according to another embodiment in the present disclosure, where the method for reconstructing an instruction in run time uses features of multiple aforementioned embodiments;

FIGS. 9b to 9d each schematically illustrate a diagram for an operating procedure of the method as shown in FIG. 9a for reconstructing an instruction in run time on an x-86 architecture processor;

FIG. 10 schematically illustrates a structural diagram for a device for reconstructing an instruction in run time according to an embodiment in the present disclosure;

FIG. 11 schematically illustrates a structural diagram for a device for reconstructing an instruction in run time according to another embodiment in the present disclosure;

FIG. 12 schematically illustrates a structural diagram for an instruction reconstruction unit according to an embodiment in the present disclosure;

FIG. 13 schematically illustrates a structural diagram for a device for reconstructing an instruction in run time according to another embodiment in the present disclosure;

FIG. 14 schematically illustrates a structural diagram for a device for reconstructing an instruction in run time according to another embodiment in the present disclosure;

FIG. 15 schematically illustrates a system hierarchy diagram for a computing device according to an embodiment in the present disclosure;

FIG. 16 illustrates a flow diagram for an initialization procedure during data security access according to an embodiment in the present disclosure;

FIG. 17 schematically illustrates a bitmap according to an embodiment in the present disclosure;

FIG. 18 illustrates a flow diagram for a data security storage method according to an embodiment in the present disclosure;

FIG. 19 illustrates a flow diagram for a data security reading method according to an embodiment in the present disclosure;

FIG. 20 illustrates a flow diagram for a data security access method according to an embodiment in the present disclosure;

FIG. 21 illustrates a flow diagram for a data security transmission method according to an embodiment in the present disclosure;

FIG. 22 schematically illustrates a network environment diagram according to an embodiment in the present disclosure;

FIG. 23 schematically illustrates a structural diagram for a data security storage device according to an embodiment in the present disclosure;

FIG. 24 schematically illustrates a structural diagram for a data security reading device according to an embodiment in the present disclosure;

FIG. 25 schematically illustrates a structural diagram for a data security storage and reading device according to an embodiment in the present disclosure;

FIG. 26 schematically illustrates a structural diagram for a data security storage and reading device according to another embodiment in the present disclosure;

FIG. 27 schematically illustrates a diagram of a data black hole space according to an embodiment in the present disclosure; and

FIG. 28 illustrates a flow diagram for a data black hole processing method according to an embodiment in the present disclosure;

### DETAILED DESCRIPTION

In order to clarify the objects, characteristics and advantages of the present disclosure, embodiments of the present disclosure will be described in conjunction with the accompanying drawings. It should be noticed that the embodiments are presented merely for clarifying the present disclosure, yet the embodiments impose no limitation to the present disclosure. Further, on the premise of no conflict, the embodiments of the present disclosure and features of the embodiments can be combined.

### Analysis

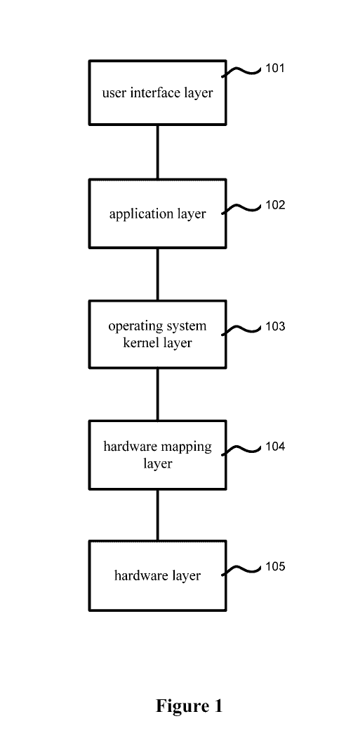

FIG. 1 schematically illustrates a system hierarchy diagram for a computing device in a conventional art, where, from the top down, the computing device includes:

a user interface layer 101, an application layer 102, an operating system kernel layer 103, a hardware mapping layer 104 and a hardware layer 105.

The user interface layer 101 is an interface between a user and the computing device, and the user communicates with the computing device (namely, the other layers of the computing device, such as the application layer 102) using the user interface layer 101. The application layer 102 refers to an application software layer.

The operating system kernel layer 103 is a logic layer based on software. Generally, the operating system kernel layer 103 consists of software data and software codes. Compared to the user interface layer 101 and the application layer 102, the software codes of the operating system kernel layer 103 possesses a higher authority, where the software codes can perform a complete operation on various software and hardware resources in a computer system.

The hardware mapping layer 104 is a logic layer based on software. Generally, the hardware mapping layer 104 works in the operating system kernel layer 103 and has a same authority as the operating system kernel layer 103. The hardware mapping layer 104 is mainly used for mapping operating modes for different types of hardware to a uniform upper layer interface and avoiding specialty of the different types of hardware to the upper layers. Generally speaking, the hardware mapping layer 104 is mainly used by the operating system kernel layer 103 for completing operations on various hardware.

The hardware layer 105 refers to all hardware used for forming the computer system.

Regarding to an operating procedure for the aforementioned system hierarchy of a computing device, an example of a data storage operation is given below. The data storage operation includes the following steps.

(1) a user executes the data storage operation using the user interface layer 101 provided by an application.

(2) the application layer 102 calls a corresponding piece of code for converting the user operation into one or more interface functions provided by an operating system (e.g., Application Programming Interface on the Microsoft 32-bit platform, win32 API). That is, the data storage operation is converted into a call for the one or more interface functions provided by the operating system kernel layer 103.

(3) the operating system kernel layer 103 converts each of the one or more interface functions provided by the operating system into one or more interface functions provided by the hardware mapping layer 104. That is, the data storage operation is converted into a call for the one or more interface functions provided by the hardware mapping layer 104;

(4) the hardware mapping layer 104 converts each of the one or more interface functions provided by the hardware mapping layer 104 into one or more hardware instruction calls.

(5) the hardware layer 105 (e.g., Central Processing Unit, CPU) receives the one or more hardware instruction calls and executing corresponding hardware instructions.

For the computing device, after being invaded by a piece of malicious code, the piece of malicious code can acquire needed data from the computing device. Posterior to stealing the data, the piece of malicious code may have the following behavioral modes including:

(1) storing the data, that is, storing a target data content into a storage location;

(2) transmitting the data, that is, transmitting the target data content to a destination address directly through a network.

Furthermore, internal divulgement caused by a staff using the aforementioned computing device or an informational device may have following behavioral modes including:

(1) active divulgement: a confidential staff acquires confidential data directly using approaches such as active duplication, penetrating a security system using a malicious tool, embedding the Trojan virus, etc., so that the confidential data is divulged;

(2) passive divulgement: a computer or a storage medium used by the confidential staff is lost because of inappropriate safekeeping or is used improperly (e.g., a device containing the confidential data is connected to the Internet directly), which results in a divulgement.

The aforementioned multiple ways of divulgement makes it hard to ensure data security of the computing device.

The inventor finds that during operation of a computer, a CPU address register, for example, a Program Counter (PC), is adapted to store an address of a next machine instruction to be executed. Data in the CPU address register is acquired, and, based on an address to which the data points, one or more machine instructions, which are going to be executed next, are read, so that capturing a machine instruction in run time can be realized.

Further, by changing an instruction segment to be dispatched that consists of the one or more machine instructions (e.g., a program transfer instruction is inserted in to the instruction segment, which is called instruction reconstruction in the present disclosure), the CPU authority is re-obtained before the instruction segment is executed completely, and then, a next instruction segment to be dispatched is captured. In this case, capturing machine instructions continuously in run time can be realized.

Further, after acquiring the instruction segment to be dispatched, the one or more machine instructions in the instruction segment can be analyzed and processed, so as to realize not only instruction capture and reconstruction in run time, but also pre-determined management for the target instruction.

### Instruction Reconstruction or Instruction Tracking

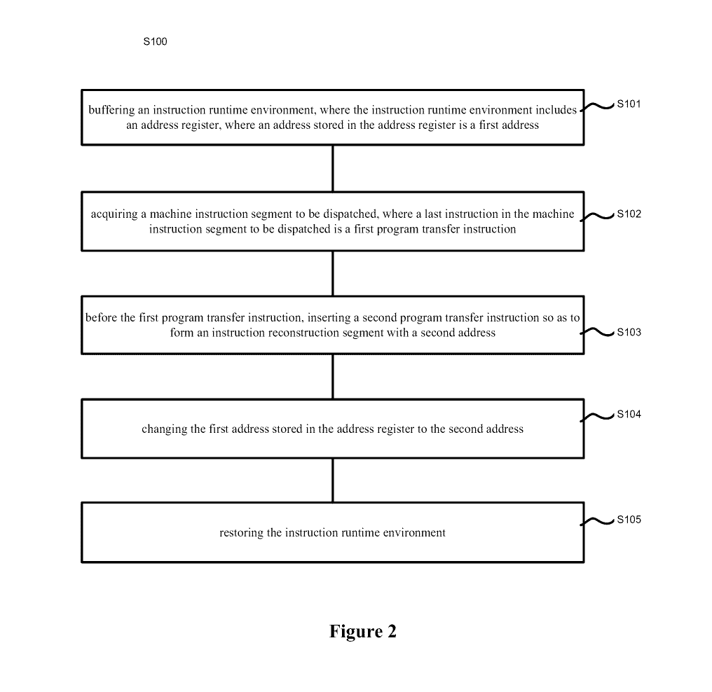

Based on the analysis and findings, the embodiments of the present disclosure provide a method for reconstructing an instruction in run time, which is called an instruction reconstruction platform when the method is being performed. As illustrated in FIG. 2, a method S100 includes the following steps.

S101, buffering an instruction runtime environment, where the instruction runtime environment includes an address register, which is adapted to store an address of a next machine instruction to be executed, where the address of the next machine instruction to be executed is a first address.

S102, acquiring a machine instruction segment to be dispatched, where a last instruction in the machine instruction segment to be dispatched is a first program transfer instruction (e.g., a first jump instruction).

S103, before the first program transfer instruction, inserting a second program transfer instruction so as to form an instruction reconstruction segment with a second address, where the second program transfer instruction points to an entrance address of an instruction reconstruction platform. That is, the step S101 is performed after the second program transfer instruction is executed.

S104, changing the first address stored in the address register to the second address.

S105, restoring the instruction runtime environment.

Wherein, the step S101 that buffering the instruction runtime environment may include: pushing corresponding register data related to execution of a CPU machine instruction into a buffering stack.

In some embodiments, the step that buffering or storing the instruction runtime environment may also be executed in other specific, default buffering data structures and addresses.

In the step S101, the address register may be a Program Counter (PC).

In the step S102, the machine instruction segment to be dispatched may only include one program transfer instruction. Specifically, the machine instruction segment to be dispatched includes the first program transfer instruction and all machine instructions to be dispatched before the first program transfer instruction.

In the step S103, before the last instruction (namely, the first program transfer instruction that is labeled as JP1) in the machine instruction segment to be dispatched, the second program transfer instruction (labeled as JP2) is inserted, where the JP2 points to the entrance address of the instruction reconstruction platform, so that the instruction reconstruction segment with the second address (labeled as A″) is formed.

Specifically, in order that the instruction reconstruction platform restarts before the JP1 is executed, when the machine instruction segment to be dispatched is executed by a CPU, the second program transfer instruction is inserted. Thus, the instruction reconstruction platform may keep analyzing a next machine instruction segment to be dispatched so as to complete reconstruction of all instructions in run time by recursion of the method.

The step 105 that restoring the instruction runtime environment includes: popping corresponding register data related to execution of an instruction from the buffering stack, where a destination address of a program transfer instruction stored in the address register has been changed to the second address A″ that is an entrance address of a new machine instruction segment.

After performing the step S105, the instruction runtime environment is restored. Operation of the instruction reconstruction platform completes. Then, a CPU executes the instruction reconstruction segment, where the CPU executes the machine instruction whose entrance address is the second address A″. When the instruction reconstruction segment is executed to the second program transfer instruction JP2, the instruction reconstruction platform re-obtains the CPU authority (namely, the step S101 is performed), and meanwhile, a destination address of the first program transfer instruction has been acquired, where the destination address of the first program transfer instruction is used to update the first address, so that the steps S101 to S105 are performed again.

In this embodiment, the method for reconstructing an instruction in run time is performed on a CPU with the x-86 architecture. In some embodiments, the method for reconstructing an instruction in run time may be performed on a Millions of Instructions Per Second (MIPS) processor or a processer based on Advanced RISC Machine (ARM) architecture. The ordinarily skilled in the art appreciates that the method may be performed on any other types of instruction processing unit in a computing device.

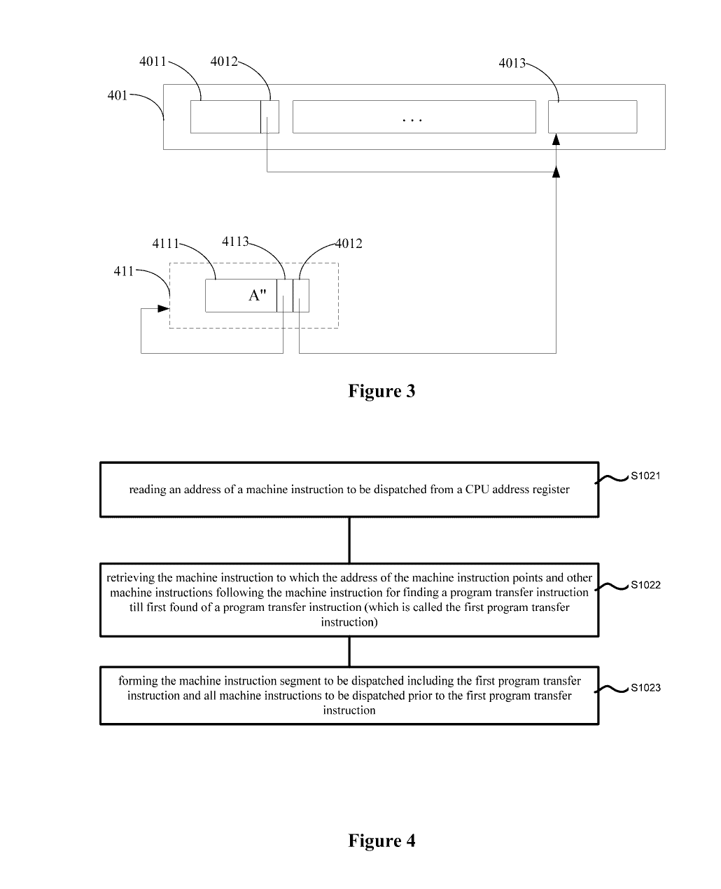

In conjunction with FIG. 3, an embodiment of a procedure for reconstructing an instruction and forming an instruction reconstruction segment is further described.

FIG. 3 illustrates a set of machine instructions 401 to be dispatched (e.g., multiple machine instructions of a program loaded in a memory), where an instruction 4012 is a first program transfer instruction. If a destination address of the instruction 4012 is a variable, it is assumed that the instruction 4012 points to a machine instruction 4013. All machine instructions to be dispatched before and including the first program transfer instruction 4012 forms a machine instruction segment 4011.

After performing the method for reconstructing an instruction (instruction reconstruction platform 411 forms), an instruction runtime environment is buffered first. Second, the machine instruction segment 4011 is acquired (e.g., by duplication). Third, the instruction reconstruction platform 411 inserts a second program transfer instruction 4113 in front of the first program transfer instruction 4012, where the second program transfer instruction 4113 points to the instruction reconstruction platform 411, so that a instruction reconstruction segment 4111 with an address A″ is formed. Fourth, an address A stored in an address register in the buffered instruction runtime environment, is changed to the address A″. Finally, the instruction runtime environment is restored.

After operation of the instruction reconstruction platform 411 ceases, a CPU executes the instruction reconstruction segment 4111 with the address A″. When the second program transfer instruction 4113 is reached, the instruction reconstruction platform 411 may re-obtain the CPU authority. The destination address 4013 of the first program transfer instruction 4012 has been formed, where the destination address 4013 is used to update the first address, and the instruction reconstruction platform 411 performs the steps S101 to S105 again based on the destination address 4013 and continues analyzing the following machine instructions to be dispatched, so that the method for reconstructing an instruction in run time is completed.

In another embodiment, referring to FIG. 4, in the step S102 that acquiring the machine instruction segment to be dispatched may include the following steps.

S1021, reading an address of a machine instruction to be dispatched from an address register (e.g., a PC).

S1022, retrieving the machine instruction to which the address of the machine instruction points and other machine instructions following the machine instruction in order to find a program transfer instruction (e.g., a jump instruction) till first found of a program transfer instruction (which is called the first program transfer instruction, e.g., a jump instruction). Wherein, the program transfer instruction, such as a jump instruction, a call instruction, a return instruction, etc., refers to a machine instruction that can change an order for executing machine instructions.

S1023, forming the machine instruction segment to be dispatched including the first program transfer instruction and all machine instructions to be dispatched before the first program transfer instruction, and the machine instruction segment to be dispatched is stored in an instruction reconstruction platform or a storage location that is accessible to other instruction reconstruction platforms.

In some embodiments, a machine instruction segment to be dispatched may be acquired by finding other instruction (e.g., a writing instruction, a reading instruction, etc.) instead of the program transfer instruction. Further, the machine instruction segment is divided. In order to ensure that an instruction reconstruction platform can still obtain the CPU authority after performing the program transfer instruction, the program transfer instruction may be a second retrieve target after the other instruction is found, so that a shorter machine instruction segment is acquired.

In another embodiment, between the steps S102 and S103, the method for reconstruction an instruction in run time may further include the following steps.

The machine instruction segment to be dispatched is matched based on an instruction set so as to acquire a target machine instruction, where the instruction set is selected from a group including a set of x86 instructions, a set of MIPS instructions and a set of ARM instructions.

The target machine instruction is changed based on a predetermined way.

Accordingly, not only a run-time instruction monitor but also other processes can be completed, and the relevant embodiments are described hereinafter.

Further, in order to improve efficiency of the method for reconstructing an instruction, an instruction to be dispatched, to which a program transfer instruction with a fixed address points, is acquired together in the step S102.

In another embodiment, a method S300 for reconstructing an instruction in run time is provided, which includes the following steps.

S301, buffering an instruction runtime environment, where the instruction runtime environment includes an address register adapted to store an address of a next machine instruction to be executed, where the address of the next machine instruction to be executed is a first address.

S302, acquiring a machine instruction segment to be dispatched, where a last instruction in the machine instruction segment to be dispatched is a first program transfer instruction that is a program transfer instruction with a parameter address.

S303, before the first program transfer instruction, inserting a second program transfer instruction so as to form an instruction reconstruction segment with a second address, where the second program transfer instruction points to an entrance address of an instruction reconstruction platform. That is, the step S301 is performed after the second program transfer instruction is executed.

S304, changing the first address stored in the address register to the second address.

S305, restoring the instruction runtime environment.

Compared to the aforementioned embodiments of the method for reconstructing an instruction, the method S300 differs in that, in the step S302, the machine instruction segment to be dispatched may include multiple program transfer instructions, which include only a program transfer instruction with the parameter address. Wherein, the program transfer instruction with the parameter address is called the first program transfer instruction.

Specifically, program transfer instructions are classified into two types that:

a program transfer instruction with a parameter address and a program transfer instruction with a constant address. Wherein, a jump address of the program transfer instruction with the constant address is a constant (namely, an immediate number). However, the parameter address usually is acquired by computation that is performed by a machine instruction before the program transfer instruction with the parameter address.

Similarly, the last instruction in the machine instruction segment to be dispatched is the first program transfer instruction, and the machine instruction segment to be dispatched includes the first program transfer instruction and all machine instructions to be dispatched before the first program transfer instruction.

Further, the machine instructions generated during running a program possess a very high complexity, thus, in order to improve efficiency of the method for reconstructing an instruction in run time and save computing resources (e.g., the CPU resources) of a computing device, the instruction reconstruction segment may be stored by occupying a few storage spaces.

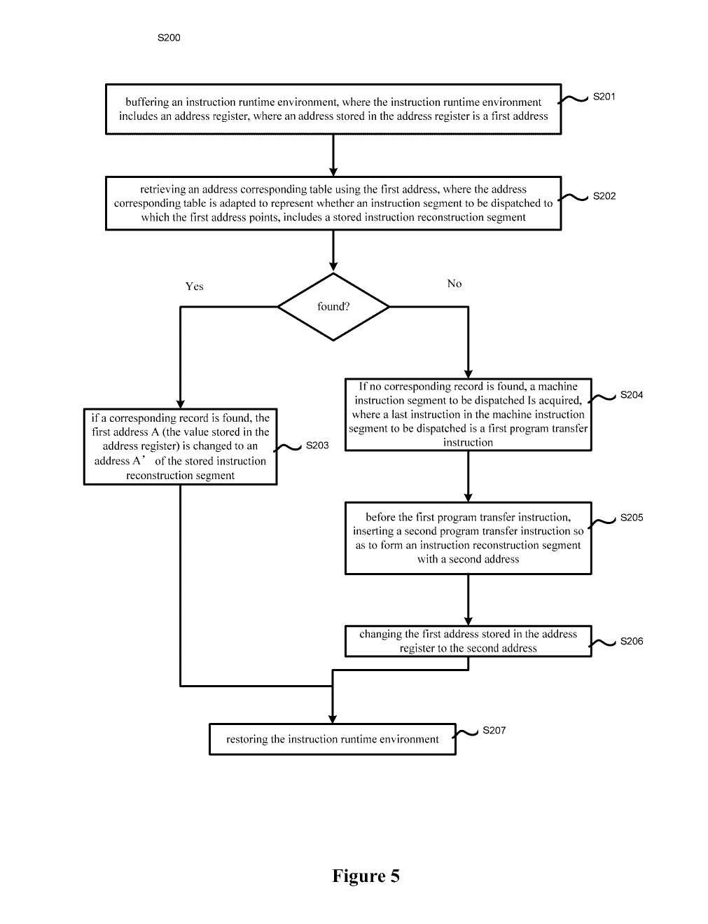

In another embodiment, a method S200 for reconstructing an instruction in run time is provided. Referring to FIG. 5, the method S200 includes the following steps.

S201, buffering an instruction runtime environment, where the instruction runtime environment includes an address register (e.g. PC) adapted to store an address of a next machine instruction to be executed, where the address of the next machine instruction to be executed is a first address. Wherein, the instruction runtime environment generally includes all types of CPU register including General Propose Registers (GPRs), statues registers, address registers, etc.

S202, retrieving an address corresponding table using the first address, where the address corresponding table is adapted to represent whether an instruction segment to be dispatched to which the first address (e.g. an address A) points, includes a stored instruction reconstruction segment. Wherein, the address corresponding table may include data such as an address pair or other forms of storage-related data.

S203, changing, if a corresponding record is found, the first address A (namely, A is stored in the address register) to an address of the stored instruction reconstruction segment (e.g., an address A′).

S204, acquiring, if no corresponding record is found, a machine instruction segment to be dispatched, where a last instruction in the machine instruction segment to be dispatched is a first program transfer instruction (e.g., a first jump instruction).

S205, inserting, before the first program transfer instruction, a second program transfer instruction so as to form an instruction reconstruction segment with a second address, where the second program transfer instruction points to an entrance address of an instruction reconstruction platform. That is, the step S201 is performed after the second program transfer instruction is executed.

S206, changing the first address stored in the address register to the second address.

S207, restoring the instruction runtime environment.

Further, the step S206 further include: forming an address pair (or a record) in the address corresponding table using the first address A and a second address A″. An instruction reconstruction segment with the address A″ is stored in the instruction reconstruction platform or a storage device that can be accessed by the instruction reconstruction platform for use again.

The method S200 employs the address corresponding table for saving computing resources, so that efficiency of run-time instruction reconstruction can be improved.

The aforementioned embodiments of the method for reconstructing an instruction generally are realized by inserting a needed program transfer instruction into an instruction segment to be dispatched. In some embodiments, the method for reconstructing an instruction may also be realized in other ways. The relevant embodiments are described hereinafter.

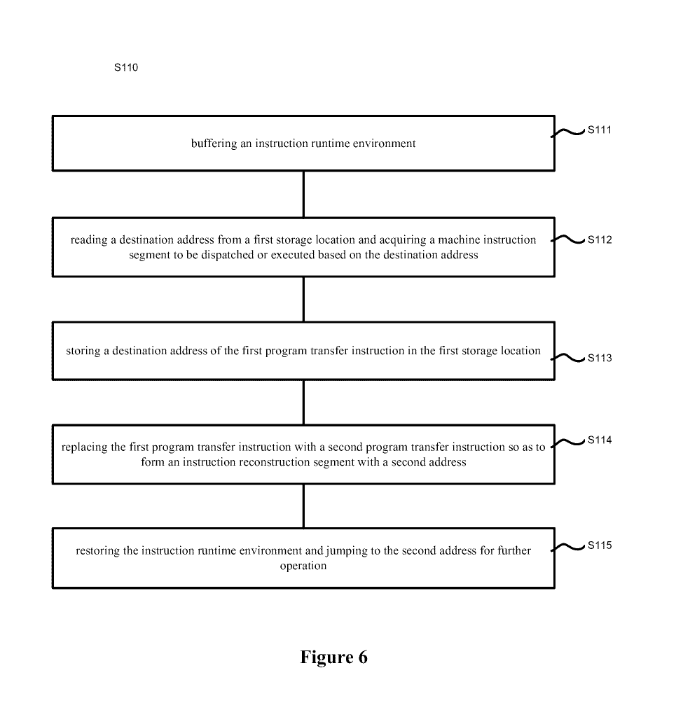

In another embodiment, a method S110 for reconstruction an instruction is provided, where a destination address of a first program transfer instruction is stored in a storage location established independently. Referring to FIG. 6, the method S110 includes the following steps.

S111, buffering an instruction runtime environment.

S112, reading a destination address from a first storage location and acquiring a machine instruction segment to be dispatched or executed based on the destination address, where a last instruction in the machine instruction segment to be dispatched is a first program transfer instruction (e.g., a first jump instruction).

S113, storing a destination address of the first program transfer instruction in the first storage location.

S114, replacing the first program transfer instruction with a second program transfer instruction so as to form an instruction reconstruction segment with a second address, where the second program transfer instruction points to an entrance address of an instruction reconstruction platform. That is, the step S111 is performed after the second program transfer instruction is executed.

S115, restoring the instruction runtime environment and jumping to the second address for further operation.

Wherein, in the step S112, acquiring the machine instruction segment to be dispatched including the following steps.

S1121, retrieving a machine instruction to which the destination address points and other instructions following the machine instruction in order to find a program transfer instruction till first found of a program transfer instruction, which is called the first program transfer instruction.

S1122, forming the machine instruction segment to be dispatched including the first program transfer instruction and all machine instructions to be dispatched before the first program transfer instruction. And, the machine instruction segment to be dispatched is stored in an instruction reconstruction platform or a storage location that is accessible to other instruction reconstruction platforms.

In the step S113, the destination address refers to a destination address parameter for a program transfer instruction, which may be an immediate number or a variable. Wherein, for the immediate number, a value is stored and for the variable, an address or a reference is stored. When a processor is going to execute a program transfer instruction, a destination address to which the program transfer instruction jumps has been computed.

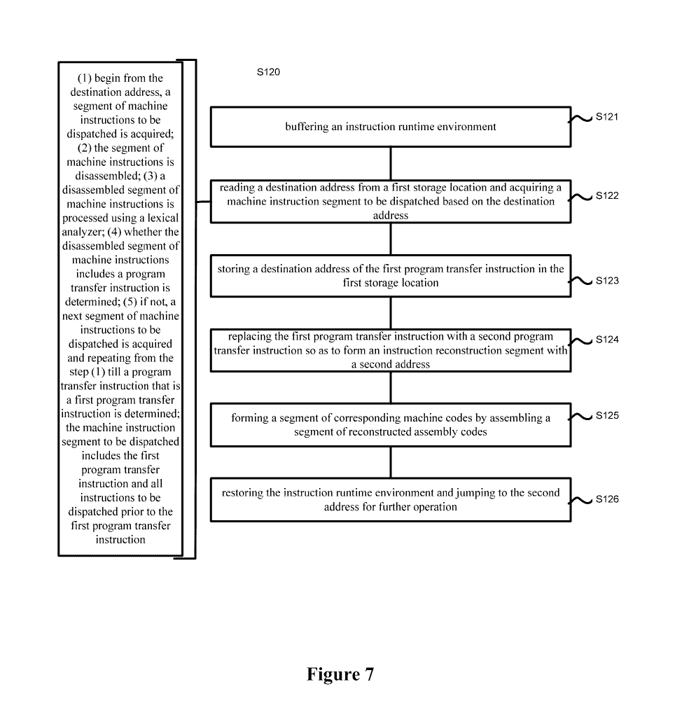

In another embodiment, a method S120 for reconstructing an instruction is provided, where disassembly and assembly are performed to a set of instructions with flexible length. Referring to FIG. 7, the method S120 includes the following steps.

S121, buffering an instruction runtime environment.

S122, reading a destination address from a first storage location and acquiring a machine instruction segment to be dispatched based on the destination address. Wherein, the step S122 includes the steps: (1) begin from the destination address, a segment of machine instructions to be dispatched is acquired; (2) the segment of machine instructions is disassembled; (3) the disassembled segment of machine instructions is processed using a lexical analyzer; (4) whether the disassembled segment of machine instructions includes a program transfer instruction (e.g., a jump instruction) is determined; (5) if not, a next segment of machine instructions to be dispatched is acquired and repeating from the step (1) till a program transfer instruction is determined, which is a first program transfer instruction. Wherein, the first program transfer instruction and all instructions before the first program transfer instruction form the machine instruction segment to be dispatched.

Wherein, the first storage location is used to store an address of a next machine instruction to be dispatched.

S123, storing a destination address of the first program transfer instruction in the first storage location.

S124, replacing the first program transfer instruction with a second program transfer instruction so as to form an instruction reconstruction segment with a second address, where the second program transfer instruction points to an entrance address of an instruction reconstruction platform. Wherein, in this embodiment, both the first program transfer instruction and the second program transfer instruction are assembly instructions.

S125, forming a segment of corresponding machine codes by assembling a segment of assembly codes in the formed instruction reconstruction segment;

S126, restoring the instruction runtime environment and jumping to the second address for further operation.

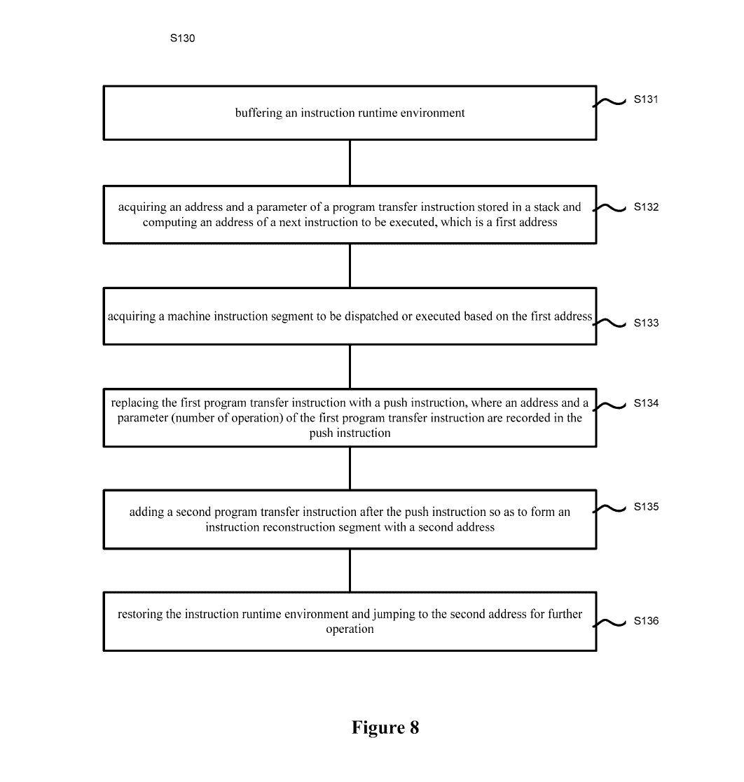

In another embodiment, a method S130 for reconstructing an instruction is provided, where a first program transfer instruction is replaced or recorded by a push instruction. Referring to FIG. 8, the method S130 includes the following steps.

S131, buffering an instruction runtime environment.

S132, performing a pop operation for acquiring a number of operations and computing an address of a next instruction to be executed, which is a first address. Wherein, a stack is used for storing an address and a parameter of a program transfer instruction (e.g., a jump instruction).

S133, acquiring a machine instruction segment to be dispatched or executed based on the first address, where a last instruction in the machine instruction segment to be dispatched is a first program transfer instruction.

S134, replacing the first program transfer instruction with a push instruction, where an address and a parameter of the first program transfer instruction are recorded in the push instruction.

S135, adding a second program transfer instruction after the push instruction so as to form an instruction reconstruction segment with a second address, where the second program transfer instruction points to an entrance address of an instruction reconstruction platform.

S136, restoring the instruction runtime environment and jumping to the second address for further operation.

The ordinarily skilled in the art appreciates that the functionalities and features provided in the aforementioned embodiments can be combined into one embodiment according to practical requirements. In the presented disclosure, instead of all possible combinations of embodiments, exemplary embodiments are described.

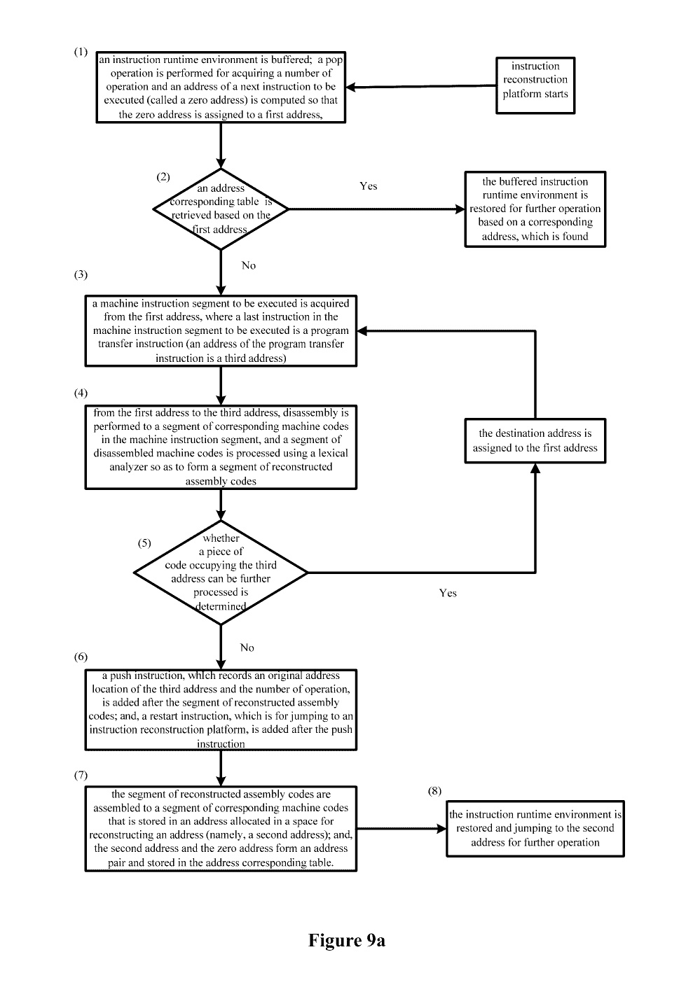

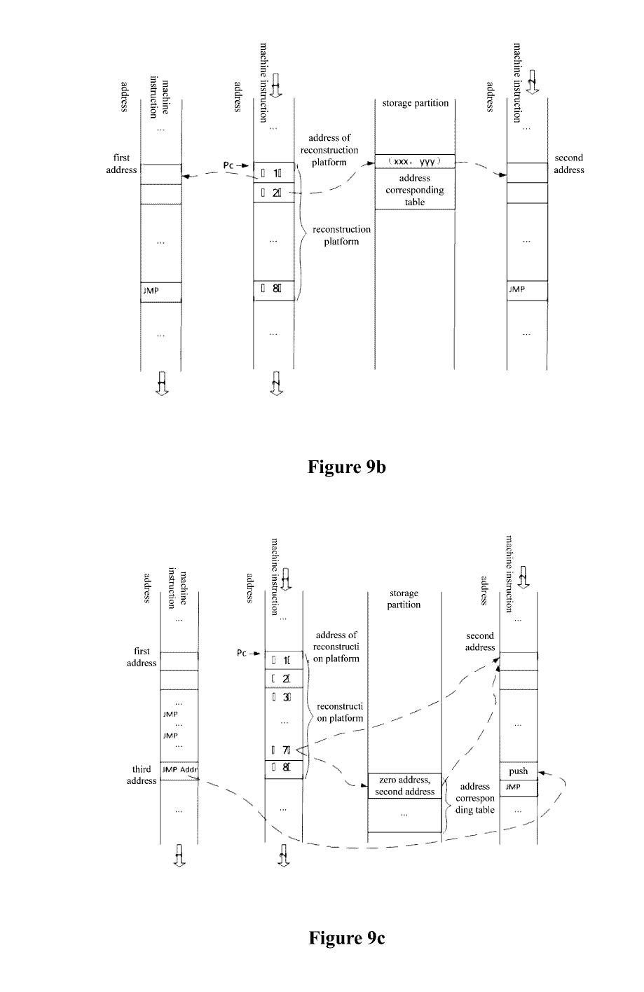

In another embodiment, a method for reconstructing an instruction is provided. Referring to FIG. 9a, the method includes following steps.

(1) An instruction runtime environment is buffered, where the instruction runtime environment generally includes all types of CPU register. A pop operation is performed for acquiring a number of operations, and an address of a next instruction to be executed (called a zero address) is computed and the zero address is assigned to a first address, where a stack is used for storing an address and a parameter of a program transfer instruction.

(2) An address corresponding table (namely, an address lookup table) is retrieved based on the first address. If a corresponding record is found, the buffered instruction runtime environment is restored for further operation based on a corresponding address, which is found, for example, based on an address pair in the address corresponding table.

(3) If no record is found, a machine instruction segment to be executed is acquired from the first address, where a last instruction in the machine instruction segment to be executed is a program transfer instruction (an address of the program transfer instruction is a third address).

(4) From the first address to the third address, disassembly is performed to a segment of machine codes in the machine instruction segment, and the segment of disassembled machine codes is processed using a lexical analyzer so as to form a segment of reconstructed assembly codes.

(5) Whether a piece of assembly code occupying the third address can be further processed is determined. That is, a destination address of the program transfer instruction that occupies the third address is known (e.g., an immediate number). If yes, the destination address is assigned to the first address, and the method is repeated from the step (3).

(6) If not, a push instruction, which records an original address of the third address (namely, a value of the third address) and the number of operations, is added after the segment of reconstructed assembly codes. And, a restart instruction, which is for jumping to an instruction reconstruction platform and restarting the method from the step (1), is added after the push instruction.

(7) The segment of reconstructed assembly codes is assembled to a segment of corresponding machine codes that is stored in an address allocated in a space for reconstructing an address (namely, a second address). And, the second address and the zero address form an address pair and are stored in the address corresponding table.

(8) The instruction runtime environment is restored and jumping to the second address for further operation.

For better understanding, an example that using an x86 architecture processor to perform the method as shown in FIG. 9a is provided. Referring to FIGS. 9b to 9d, an exemplary procedure for reconstructing an instruction is presented below.

(1) After start-up of an instruction reconstruction platform, a current instruction runtime environment is buffered first. An address and a parameter of a program transfer instruction stored in a stack are acquired, and an address of the next instruction to be executed is computed, where the address is the zero address that is assigned to the first address.

(2) The address corresponding table is retrieved using the first address. If a corresponding record is found, the buffered instruction runtime environment is restored and jumping to a found address for further operation, as shown in FIG. 9b. If no corresponding record is found, as shown in FIG. 9c, the following steps are performed.

(3) to (6) From the first address, a segment of machine codes is disassembled, and the segment of disassembled machine codes is processed using the lexical analyzer to form a segment of reconstructed assembly codes.

The segment of reconstructed assembly codes is retrieved for determining whether the segment of reconstructed assembly codes includes a program transfer instruction.

A first-found program transfer instruction is analyzed for determining whether the destination address to which the first-found program transfer instruction jumps is known. If yes, the retrieve continues till a first instruction for program transfer with a parameter address is found, which is called the first program transfer instruction below for convenience, where an address of the first program transfer instruction is the third address.

At the end of the segment of generated assembly codes (from a piece of machine code with the first address to a piece of machine code with the third address and excluding the first program transfer instruction), a push instruction is added for recording an original address before a first jump of the third address and the number of operations.

A restart instruction (namely, a second program transfer instruction), which is for jumping to the instruction reconstruction platform and restart, is added after the push instruction.

(7) The segment of generated assembly codes is assembled to a segment of corresponding machine codes that is stored in an address allocated in the space for reconstructing an address (namely, the second address). And, the second address and the zero address form the address pair and are stored in the address corresponding table.

(8) The instruction runtime environment is restored and jumping to the second address for further operation.

Referring to FIG. 9d, a processor starts executing an instruction stored in the second address. A program transfer instruction in an instruction segment to be reconstructed has been replaced with a push instruction and a restart instruction for jumping to an instruction reconstruction platform, where the push instruction provides an input parameter to the instruction reconstruction platform. Still referring to FIG. 9d, when proceeding to a second program transfer instruction, the instruction reconstruction platform re-obtains the CPU authority so as to perform the step (1) that the address of the next instruction to be executed, which is the first address, is computed based on the address and the parameter of the program transfer instruction stored in the push instruction. Next, recursion is performed to the aforementioned steps (1) to (8).

Further, in order to execute run-time instruction monitor right after system boot and realize monitoring all instructions in run time for an operating computing device, in an embodiment of the present disclosure, a load instruction is changed at boot of a computer, where, before the load instruction, the instruction reconstruction platform provided in the embodiments of the present disclosure is called, and the method for reconstructing an instruction in run time is performed. Since an address to which the load instruction jumps is a static address, the instruction reconstruction platform may establish the address corresponding table and a first record in advance, and a first instruction reconstruction segment is also established.

Further, in another embodiment, a computer readable medium is provided, where a piece of program code that can be executed by a computer is stored in the readable medium, where the piece of program code is adapted to perform the steps of the method for reconstructing an instruction in run time according to the aforementioned embodiments in the present disclosure.

Further, in another embodiment, a computer program is provided, where the computer program includes the steps of the method for reconstructing an instruction in run time according to the aforementioned embodiments in the present disclosure.

### Instruction Reconstruction for Data Security

The method for reconstructing an instruction in run time provides a basis for further applications. The following embodiments of the method for reconstructing an instruction in run time aim to processing different machine instructions, which includes a storage/reading instruction, an Input/Output (I/O) instruction and a network transmission instruction.

(1) The storage/reading instruction refers to an instruction or an instruction combination performs a storage/reading operation to all external storage devices (including but not limited to a magnetic disk storage device, a flash storage device, an optical storage device) in a computer system.

(2) The I/O instruction refers to all instructions operating an external address space in a computer system, where the instructions may affect external input/output status, data, signal, etc. The external address space includes but not limited to an I/O address space, an address space for memory mapping I/O device.

(3) The network transmission instruction refers to all instructions affecting a network device, where the instructions may affect all relevant features including transmission, status, data, signal, etc., of the network device in a computer system.

Wherein, the storage/reading instruction and the I/O instruction may overlap with each other.

In an embodiment, a method S400 for reconstructing a storage/reading instruction in run time is provided, which includes the following steps.

S401, buffering an instruction runtime environment, where the instruction runtime environment includes an address register that is adapted to store an address of a next machine instruction to be executed. Wherein, the address of the next machine instruction to be executed is a first address A. Wherein, the address register may be a Program Counter (PC).

S402, retrieving an address corresponding table using the first address A.

S403, if a corresponding record is found, changing the first address A to a stored address A′ of an instruction reconstruction segment.

S404, if no corresponding record is found, form an instruction reconstruction segment, which includes the steps hereinafter.

S4041, acquiring a machine instruction segment to be dispatched, where a last instruction of the machine instruction segment to be dispatched is a first program transfer instruction, where the step S4041 and the step S102 are identical.

S4042, disassembling the machine instruction segment to be dispatched so as to acquire an assembly instruction segment.

S4043, finding a target assembly instruction (namely, retrieving the assembly instruction segment in order to find the target assembly instruction), where the target assembly instruction is a storage/reading instruction.

S4044, if the storage/reading instruction in the assembly instruction segment is found, changing a storage address and a reading address of the storage/reading instruction to addresses on a security storage device, where the modification may be made by directly mapping between a local address space and an address space in the security storage device.

S4045, before the first program transfer instruction JP1, inserting a second program transfer instruction JP2, where the JP2 points to an entrance address of an instruction reconstruction platform (the instruction reconstruction platform may refer to the method for reconstructing an instruction that is being executed, and the instruction reconstruction platform may also refer to an embodiment performing the method for reconstructing an instruction).

S4046, assembling the changed assembly instruction segment so as to form a machine instruction reconstruction segment with an address A″.

S4047, establishing a record (or an address pair) in the address corresponding table using the address A″ of the machine instruction reconstruction segment and the first address A, and storing the machine instruction reconstruction segment with the address A″ in the instruction reconstruction platform.

S4048, changing the first address A to the address A″.

S405, restoring the instruction runtime environment.

In this embodiment, an instruction is processed after performing disassembly. In some embodiments, disassembly and assembly may not be performed, and an instruction is processed directly.

In the step S4044, when executing a storage instruction and a reading instruction, a destination address and a source address are changed respectively, so that storage relocation or redirection can be realized for ensuring data security. The embodiments for a more detailed security storage/reading method are provided hereinafter in the present disclosure.

In an embodiment, a method S500 for reconstructing an I/O instruction in run time is provided, which includes the following steps.

S501, buffering an instruction runtime environment, where the instruction runtime environment includes an address register that is adapted to store an address of a next machine instruction to be executed. Wherein, the address is a first address A.

S502, retrieving an address corresponding table using the first address A.

S503, if a corresponding record is found, changing the first address A to a stored address A′ of an instruction reconstruction segment.

S504, if no corresponding record is found, form an instruction reconstruction segment, which includes the steps hereinafter.

S5041, acquiring a machine instruction segment to be dispatched, where a last instruction of the machine instruction segment to be dispatched is a first program transfer instruction, where the step S5041 and the step S102 are identical.

S5042, disassembling the machine instruction segment to be dispatched so as to acquire an assembly instruction segment.

S5043, finding a target assembly instruction, where the target assembly instruction is an I/O instruction.

S5044, if the I/O instruction in the assembly instruction segment is found, an input instruction in the I/O instruction is blocked.

S5045, inserting a second program transfer instruction JP2 before the first program transfer instruction JP1, where the JP2 points to an entrance address of an instruction reconstruction platform.

S5046, assembling the changed assembly instruction segment so as to form a machine instruction reconstruction segment with an address A″.

S5047, establishing a record (or an address pair) in the address corresponding table using the address A″ of the machine instruction reconstruction segment and the first address A and storing the machine instruction reconstruction segment with the address A″ in the instruction reconstruction platform.

S5048, changing the first address A to the address A″.

S505, restoring the instruction runtime environment.

In this embodiment, an instruction is processed after performing disassembly. In some embodiments, disassembly and assembly may not be performed, and an instruction is processed directly.

In the step S5044, when executing the I/O instruction, an input instruction in the I/O instruction is blocked, so that completely blocking a writing operation performed to a local hardware device can be realized for ensuring data security. In conjunction with the previous embodiment for processing the storage instruction, it can be realized that all input instructions except for the storage instruction are blocked so that data security in a computing device can be improved.

In an embodiment, a method S600 for reconstructing a network transmission instruction in run time is provided, which includes the following steps.

S601, buffering an instruction runtime environment, where the instruction runtime environment includes an address register that is adapted to store an address of a next machine instruction to be executed. Wherein, the address is a first address A.

S602, retrieving an address corresponding table using the first address A.

S603, if a corresponding record is found, changing the first address A to a stored address of an instruction reconstruction segment A′.

S604, if no corresponding record is found, form an instruction reconstruction segment, which includes the steps hereinafter.

S6041, acquiring a machine instruction segment to be dispatched, where a last instruction of the machine instruction segment to be dispatched is a first program transfer instruction, where the step S6041 and the step S102 are identical.

S6042, disassembling the machine instruction segment to be dispatched so as to acquire an assembly instruction segment.

S6043, finding a target assembly instruction, where the target assembly instruction is a network transmission instruction.

S6044, if the network transmission instruction in the assembly instruction segment is found, determining whether a remote computing device corresponding to a destination address in the network transmission instruction is a secure address (e.g. a white list). If not, the network transmission instruction is blocked.

S6045, inserting a second program transfer instruction JP2 before the first program transfer instruction JP1, where the JP2 points to an entrance address of an instruction reconstruction platform.

S6046, assembling the changed assembly instruction segment so as to form a machine instruction reconstruction segment with an address A″.

S6047, establishing a record (or an address pair) in the address corresponding table using the address A″ of the machine instruction reconstruction segment and the first address A and storing the machine instruction reconstruction segment with the address A″ in the instruction reconstruction platform.

S6048, changing the first address A to the address A″.

S605, restoring the instruction runtime environment.

In the step S6044, the network transmission instruction is rejected/blocked by inserting one or more instructions in a segment of reconstructed codes so that, based on different hardware, the network transmission instruction is replaced with an instruction for cancelling a current operation or an invalid instruction.

In this embodiment, an instruction is processed after performing disassembly. In some embodiments, disassembly and assembly may not be performed, and an instruction is processed directly.

In the step S6044, when executing the network transmission instruction, whether a remote computing device corresponding to a destination address in the network transmission instruction is secure is determined. If not, the network transmission instruction is blocked so as to realize security data transmission.

In the aforementioned multiple embodiments, the instruction reconstruction platform establishes and maintains the address corresponding table, which may be a data structure with a constant length or a list structure with a flexible length or other appropriate data structures for storing binary data. In an embodiment, the address corresponding table may have a flexible length, and the memories occupied by the address corresponding table may be released. An operation for releasing the memories occupied by the address corresponding table may be performed randomly or periodically. In an embodiment, the address corresponding table may further include an establishing time field that is adapted to, when releasing the memories and deleting a record, delete the record based on establishing time duration. In an embodiment, the address corresponding table may further include a use frequency record field. During retrieving the address corresponding table, if a corresponding record is found, the use frequency record field is changed, where the use frequency record field is further adapted to, when releasing the memories and deleting the record, delete the record based on use frequency.

Furthermore, the ordinarily skilled in the art appreciates that the aforementioned instruction reconstruction method (namely, the method for reconstructing an instruction in run time) may be realized using software or hardware.

(1) if the method is realized using software, the corresponding steps of the method are stored in a computer readable medium in a form of software code so as to form a software product.

(2) if the method is realized using hardware, the corresponding steps of the method are programmed by hardware code (e.g., Verilog) and then, substantialized (through a procedure including physical design, placement and routing, tape-out, etc.) into a chip product (e.g., a processor). Detailed descriptions are provided below.

### Instruction Reconstruction Device

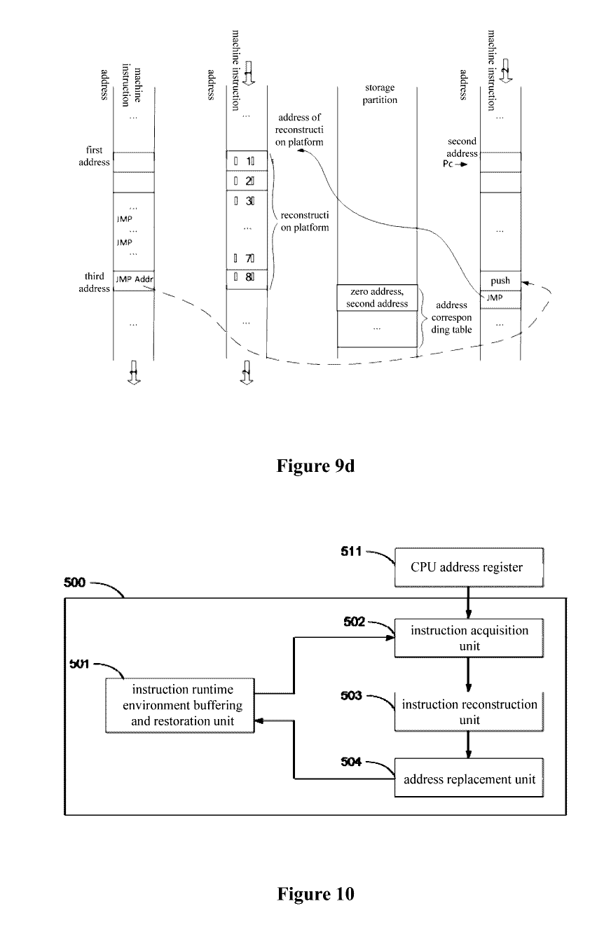

Corresponding to the method S100 for reconstructing an instruction in run time, in an embodiment, a device 500 for reconstructing an instruction in run time is provided. Referring to FIG. 10, the device 500 includes the following units.

An instruction runtime environment buffering and restoration unit 501 that is adapted to buffer and restore an instruction runtime environment, where the instruction runtime environment includes an address register (e.g., a Program Register, PC), which is adapted to store an address of a next machine instruction to be executed. Wherein, the address of the next machine instruction to be executed is a first address.

An instruction acquisition unit 502 that is adapted to acquire a machine instruction segment to be dispatched after the instruction runtime environment buffering and restoration unit 501 buffers the instruction runtime environment, where a last instruction in the machine instruction segment to be dispatched is a first program transfer instruction (e.g., a first jump instruction).

An instruction reconstruction unit 503 that is adapted to analyze and change the machine instruction segment to be dispatched. Wherein, before the first program transfer instruction, the instruction reconstruction unit 503 is adapted to insert a second program transfer instruction so as to form an instruction reconstruction segment with a second address A″. Wherein, the second program transfer instruction points to the device 500, that is, the instruction runtime environment buffering and restoration unit 501 of the device 500 performs a next process after the second program transfer instruction is executed.

An address replacement unit 504 that is adapted to change a value stored in the address register in the buffered instruction runtime environment to an address of the instruction reconstruction segment.

Specifically, the instruction runtime environment buffering and restoration unit 501 is coupled with the instruction acquisition unit 502 and the address replacement unit 504 respectively. The instruction acquisition unit 502, the instruction reconstruction unit 503 and the address replacement unit 504 are one-by-one coupled.

The procedure for operating the device 500 is provided in following.

First, the instruction runtime environment buffering and restoration unit 501 buffers an instruction runtime environment. For example, register data related to execution of an instruction is pushed into a buffer stack.

Second, the instruction acquisition unit 502 reads an address of a machine instruction to be dispatched from a CPU address register 511 and reads a machine instruction segment from the address of the machine instruction to be dispatched, where a last instruction of the machine instruction segment is a program transfer instruction.

An example is given that the instruction acquisition unit 502 reads the address of the machine instruction to be dispatched from a CPU address register 511 first. The machine instruction to be dispatched corresponding to the address is retrieved in order to find a program transfer instruction till a first program transfer instruction (namely, control transfer instructions including an unconditional transfer instruction and a conditional transfer instruction) is found, where the program transfer instruction may include: a jump/JMP instruction, a call instruction, RET instruction, etc. The machine instruction segment to be dispatched including the first program transfer instruction and all machine instructions to be dispatched before the first program transfer instruction, is formed, and the machine instruction segment to be dispatched is stored in the device 500 or any other storage location that is accessible to the device 500.

Third, before the last instruction in the machine instruction segment, the instruction reconstruction unit 503 inserts a second program transfer instruction, where the second program transfer instruction points to an entrance address of the device 500, so that the instruction reconstruction segment with the second address A″ is formed.

Next, the address replacement unit 504 changes a value A stored in the address register in the buffered instruction runtime environment to the second address A″.

At least, the instruction runtime environment buffering and restoration unit 501 restores the instruction runtime environment. For example, register data related to execution of an instruction is popped out from the buffer stack.

Corresponding to the method S300 for reconstructing an instruction in run time, a first instruction for program transfer with a non-constant address may be a first program transfer instruction, so that operating efficiency of the device can be improved.

Corresponding to the method S200 for reconstructing an instruction in run time, in another embodiment, a device 600 for reconstructing an instruction in run time is provided which fully takes advantage of run-time instruction recursion to improve efficiency and save computing resources.

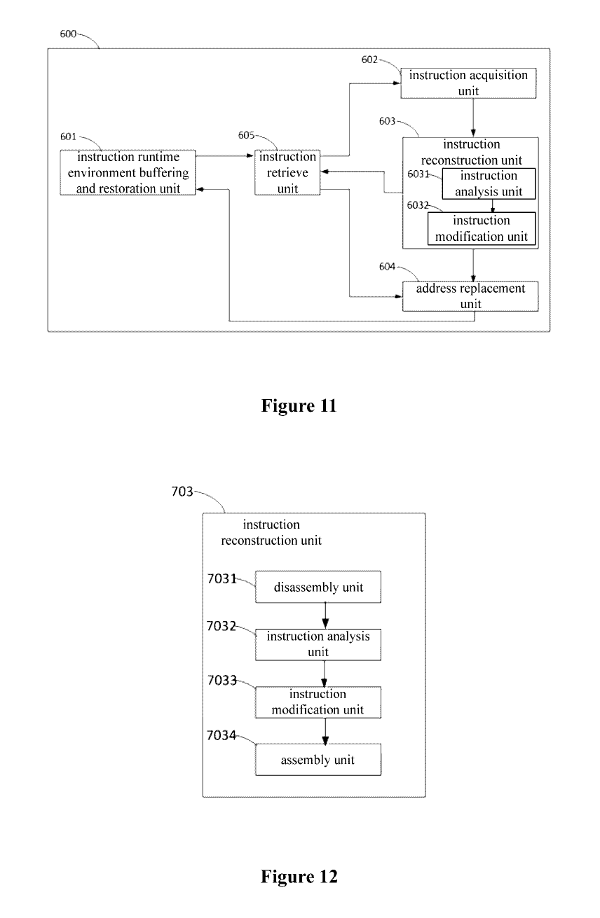

Referring to FIG. 11, the device 600 includes the following units.

An instruction runtime environment buffering and restoration unit 601 that is adapted to buffer and restore an instruction runtime environment, where the instruction runtime environment includes an address register, which is adapted to store an address of a next machine instruction to be executed. Wherein, the address of the next machine instruction to be executed is a first address.

An instruction acquisition unit 602 that is adapted to acquire a machine instruction segment to be dispatched, where a last instruction in the machine instruction segment to be dispatched is a first program transfer instruction.

An instruction reconstruction unit 603 that is adapted to analyze and change the machine instruction segment to be dispatched, which includes: before the first program transfer instruction, the instruction reconstruction unit 603 is adapted to insert a second program transfer instruction so as to form an instruction reconstruction segment with a second address. Wherein, the second program transfer instruction points to the device 600, that is, the instruction runtime environment buffering and restoration unit 601 of the device 600 performs a next process after the second program transfer instruction is executed.

An address replacement unit 604 that is adapted to change a value stored in the address register in the buffered instruction runtime environment to an address of the instruction reconstruction segment.

An instruction retrieving unit 605 that is adapted to retrieve an address corresponding table using the first address, where the address corresponding table is adapted to represent whether an instruction segment to be dispatched to which the first address A points, includes a stored instruction reconstruction segment. Wherein, the address corresponding table may include data such as an address pair. If a corresponding record is found, the instruction retrieving unit 605 is adapted to call the address replacement unit 604 for changing the first address A (namely, the value A stored in the address register) to an address A″ of the stored instruction reconstruction segment. If no corresponding record is found, the instruction retrieving unit 605 is adapted to establish a record in the address corresponding table using the address A″ and the first address A.

Specifically, the instruction runtime environment buffering and restoration unit 601 is coupled with the address replacement unit 604 and the instruction retrieving unit 605 respectively. The instruction retrieving unit 605 is coupled with the instruction acquisition unit 602, the instruction reconstruction unit 603 and the address replacement unit 604 respectively. The instruction acquisition unit 602, the instruction reconstruction unit 603 and the address replacement unit 604 are one-by-one coupled.

The procedure for operating the device 600 is provided in following.

First, the instruction runtime environment buffering and restoration unit 601 buffers an instruction runtime environment. For example, register data related to execution of an instruction is pushed into a buffer stack.

Second, the instruction retrieving unit 605 retrieves an address corresponding table using the value A stored in the address register in the buffered instruction runtime environment.

If a corresponding record is found, the instruction retrieving unit 605 calls the address replacement unit 604, where the address replacement unit 604 changes the value A stored in the address register to a value A′ in the record. The address replacement unit 604 calls the instruction runtime environment buffering and restoration unit 601 for restoring the instruction runtime environment, that is, register data related to execution of an instruction is popped out from the buffer stack and the reconstruction operation is completed.

If no corresponding record is found, the instruction acquisition unit 602 reads an address of a machine instruction to be dispatched from a CPU address register and reads a machine instruction segment from the address of the machine instruction, where a last instruction of the machine instruction segment is a program transfer instruction. Specifically, the instruction acquisition unit 602 reads the address of the machine instruction to be dispatched from the CPU address register first. The machine instruction corresponding to the address is retrieved for finding the program transfer instruction till a first program transfer instruction is found, where the program transfer instruction may be an instruction such as a jump instruction, a call instruction, etc. The machine instruction segment to be dispatched including the first program transfer instruction and all machine instructions to be dispatched before the first program transfer instruction, is formed, and the machine instruction segment to be dispatched is stored in the device 600 or any other storage location that is accessible to the device 600.

Third, before the last instruction in the machine instruction segment, the instruction reconstruction unit 603 inserts a second program transfer instruction, where the second program transfer instruction points to an entrance address of the device 600, so that the instruction reconstruction segment with the second address A″ is formed.

Fourth, the instruction reconstruction unit 603 sends the address A″ to the instruction retrieving unit 605, and the instruction retrieving unit 605 establishes a record in the address corresponding table using the second address A″ and the address A in case for the following instruction recursion.

Next, the address replacement unit 604 changes the value A stored in the address register in the buffered instruction runtime environment to the second address A″.

At least, the instruction runtime environment buffering and restoration unit 601 restores the instruction runtime environment. That is, corresponding register data related to execution of an instruction is popped out from the buffer stack.

Referring to FIG. 11, the instruction reconstruction unit 603 may further include: an instruction analysis unit 6031 that is adapted to match the machine instruction segment to be dispatched using an instruction set, so as to acquire a target machine instruction to be executed (namely, the machine instruction segment to be dispatched is retrieved for finding the target machine instruction), where the instruction set is selected from a group including a set of x86 instructions, a set of MIPS instructions and a set of ARM instructions; and an instruction modification unit 6032 that is adapted to change the target machine instruction based on a predetermined way.

An example is given that if the target machine instruction is a storage/reading instruction, the instruction analysis unit 6031 is adapted to acquire the storage/reading instruction in a machine instruction segment to be dispatched, and the instruction modification unit 6032 is adapted to change a storage address and a reading address of the storage/reading instruction to addresses in a security storage device. In this case, the device 600 has a same effect as the corresponding method S400, thus no more tautology here.

Another example is given that if the target machine instruction is an I/O instruction, the instruction analysis unit 6031 is adapted to acquire the I/O instruction in a machine instruction segment to be dispatched, and the instruction modification unit 6032 is adapted to block all input instructions in the I/O instruction. In this case, the device 600 has a same effect as the corresponding method S500, thus no more tautology here.

Another example is given that if the target machine instruction is a network transmission instruction, the instruction analysis unit 6031 is adapted to acquire the network transmission instruction in a machine instruction segment to be dispatched, and the instruction modification unit 6032 is adapted to determine whether a remote computing device corresponding to the target machine instruction in the network transmission instruction is secure. If not, the instruction modification unit 6032 is adapted to block the network transmission instruction. In this case, the device 600 has a same effect as the corresponding method S600, thus no more tautology here.

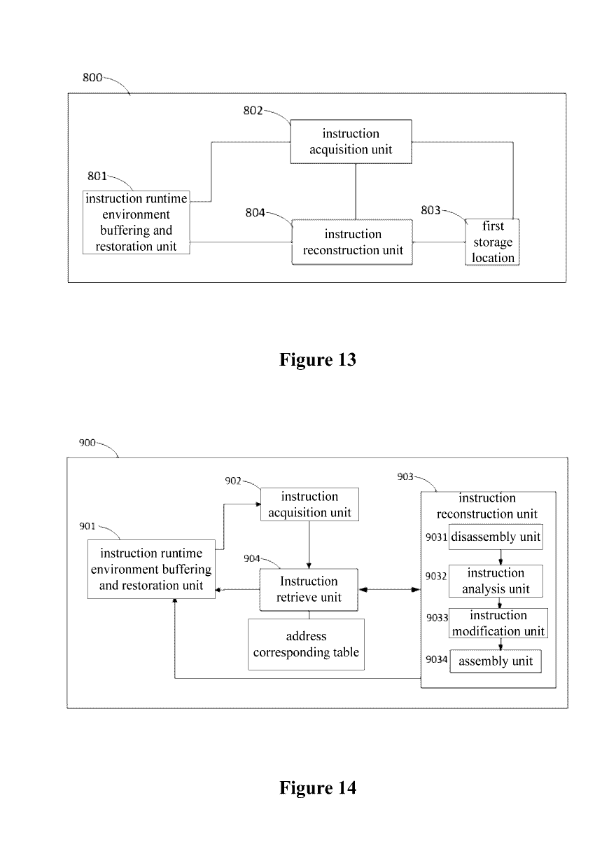

In another embodiment, the aforementioned instruction reconstruction unit may further include a disassembly unit and an assembly unit. Referring to FIG. 12, an instruction reconstruction unit 703 includes: a disassembly unit 7031, an instruction analysis unit 7032, an instruction modification unit 7033 and an assembly unit 7034, where the unit 7031, the unit 7032, the unit 7033 and the unit 7034 are coupled one by one.

Wherein, the disassembly unit 7031 is adapted to disassemble the machine instruction segment to be dispatched prior to analyzing and changing the machine instruction segment to be dispatched, so as to form an assembly instruction segment to be dispatched that is sent to the instruction analysis unit 7032.

Wherein, the assembly unit 7034 is adapted to assemble a reconstructed assembly instruction segment posterior to analyzing and changing the machine instruction segment to be dispatched, so as to acquire an instruction reconstruction segment represented by a segment of machine codes that is sent to an instruction replacement unit.

In this embodiment, the instruction analysis unit 7032 and the instruction modification unit 7033 are adapted to execute the assembly instruction segment to be dispatched, where the operating method is similar to the method in the aforementioned embodiment, thus no more tautology here.

Corresponding to the method S110 for reconstructing an instruction in run time, in another embodiment, a device 800 for reconstructing an instruction in run time is provided. Referring to FIG. 13, the device 800 includes the following units.

An instruction runtime environment buffering and restoration unit 801 that is adapted to buffer an instruction runtime environment and restore the instruction runtime environment.

An instruction acquisition unit 802 and a first storage location 803, where the instruction acquisition unit 802 is adapted to read a destination address from the first storage location 803 and acquire a machine instruction segment to be dispatched/executed based on the destination address, where a last instruction in the machine instruction segment to be dispatched is a first program transfer instruction.

An instruction reconstruction unit 804 that is adapted to store a destination address of the first program transfer instruction in the first storage location 803, and replace the first program transfer instruction with a second program transfer instruction so as to form an instruction reconstruction segment with a second address, where the second program transfer instruction points to an entrance address of the device 800.

Wherein, the instruction runtime environment buffering and restoration unit 801 is further adapted to restore the instruction runtime environment after instruction replacement is performed by the instruction reconstruction unit 804 and jumping to the second address for further operation.

The procedure for operating the device 800 is provided below.

First, the instruction runtime environment buffering and restoration unit 801 buffers an instruction runtime environment.

Second, the instruction acquisition unit 802 reads a destination address (an address of an instruction to be dispatched) from the first storage location 803 and acquires a machine instruction segment to be dispatched based on the destination address, where a last instruction in the machine instruction segment to be dispatched is the first program transfer instruction.

Third, the instruction reconstruction unit 804 stores a destination address of the first program transfer instruction in the first storage location 803: (1) for an immediate number, a value of the immediate number is stored; (2) for a variable, an address/reference of the variable is stored. For example, an address or reference of a variable with float type called destination address is stored.

Next, the instruction reconstruction unit 804 replaces the first program transfer instruction with a second program transfer instruction so as to form an instruction reconstruction segment with a second address.

At least, the instruction runtime environment buffering and restoration unit 801 restores the instruction runtime environment and jumping to the second address for further operation.

Corresponding to the method S130 for reconstructing an instruction in run time, in another embodiment, a device 900 for reconstructing an instruction in run time is provided, and the device includes features of the device provided in aforementioned embodiments. Referring to FIG. 14, the device 900 includes the following units.

An instruction runtime environment buffering and restoration unit 901 that is adapted to buffer an instruction runtime environment and restore the instruction runtime environment.

An instruction acquisition unit 902 that is adapted to perform a pop operation to acquire a number of operations, further adapted to compute an address of a next instruction to be executed that is a first address.

The instruction acquisition unit 902 is further adapted to acquire a machine instruction segment to be dispatched or executed based on the first address. Wherein, a last instruction in the machine instruction segment to be dispatched is a first program transfer instruction.

An instruction reconstruction unit 903 that is adapted to replace the first program transfer instruction with a push instruction, where an address of the first program transfer instruction is recorded in the push instruction.

The instruction reconstruction unit 903 that is further adapted to add a second program transfer instruction after the push instruction so as to form an instruction reconstruction segment with a second address. Wherein, the second program transfer instruction points to an entrance address of the device 900.

The instruction reconstruction unit 903 is further adapted to establish a record using the first address and the second address of the instruction reconstruction segment in an address corresponding table.

An instruction retrieve unit 904, adapted to retrieve the address corresponding table using the first address, where the address corresponding table is adapted to represent whether an instruction segment to be dispatched to which the first address points to includes a stored instruction reconstruction segment. Wherein, the address corresponding table may include data such as an address pair.

If a corresponding record is found, the instruction retrieve unit 904 is adapted to call the instruction runtime environment buffering and restoration unit 901 for restoring the buffered instruction runtime environment and jumping to a found address for further operation (so that the current reconstruction operation is completed).

If no corresponding record is found, the instruction reconstruction unit 903 is adapted to perform a reconstruction operation.

Wherein, the instruction reconstruction unit 903 may further include: a disassembly unit 9031, an instruction analysis unit 9032, an instruction modification unit 9033 and an assembly unit 9034.

Wherein, after the instruction reconstruction unit 903 completes reconstruction, the instruction runtime environment buffering and restoration unit 901 is called for restoring the buffered instruction runtime environment and jumping to the second address of the instruction reconstruction segment for further operation (the current reconstruction operation is completed).

In another embodiment, the disassembly unit 9031 may be disposed inside the instruction acquisition unit 902, where a disassembly operation is performed when an instruction segment to be dispatched is acquired.

The ordinarily skilled in the art appreciates that arrows for data stream in figures of the aforementioned embodiments of the device are only for convenience in describing the detailed operating procedure in the aforementioned embodiments, which impose no limitation on the flow direction of the data stream between the units as shown in the figures. The units of the device are coupled.

The aforementioned embodiments describe the method and device for reconstructing an instruction in run time in detail. Compared to a conventional art, the method and the device have the following advantages.

By using the method for reconstructing an instruction, an instruction being executed in a computing device is under monitor.

By employing an address correspondent table, efficiency of reconstructing an instruction is improved, and computing resources is conserved.

When executing a storage instruction and a reading instruction, a destination address and a source address are changed respectively, so that storage relocation or redirection can be realized for assuring data security.

When executing the I/O instruction, input instructions in the I/O instruction are entirely blocked, so that completely blocking a writing operation to a local hardware device can be realized for ensuring data security. It can be realized that all input instructions except for the storage instruction are blocked so that data security in a computing device can be improved.

When executing the network transmission instruction, whether a remote computing device corresponding to a destination address in the network transmission instruction is secure is determined. If not, the network transmission instruction is blocked so as to realize security data transmission.

### Data Security Access Procedure

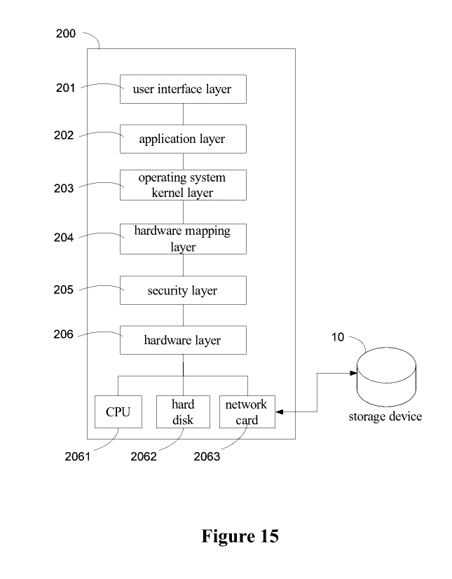

FIG. 15 schematically illustrates a system hierarchy diagram for a computing device 200 according to an embodiment in the present disclosure.

Wherein, the computing device 200 (e.g. a computer terminal system) includes: a user interface layer 201, an application layer 202, an operating system kernel layer 203, a hardware mapping layer 204, a security layer 205 and a hardware layer 206.

Wherein, the hardware layer 206 further includes a CPU 2061, a hard disk 2062 (that is, a local storage device) and a network card 2063.

In addition, the computing device 200 and a storage device 10 (also called a security storage device) are coupled.

In this embodiment, the storage device 10 is a remote disk array that communicates with the computing device 200 by a network connecting the network card 2063 of the hardware layer 206. In other embodiments, the storage device 10 may be other known or unknown types of storage device.

Wherein, the hard disk 2062 may be replaced by other types of local storage device, such as a flash stick, an optical disk, etc., which are examples and not for imposing limitation.

In conjunction with the system hierarchy structure, a data security access procedure is provided, which includes: S1000, initialization; S2000, data writing; and S3000, data reading.

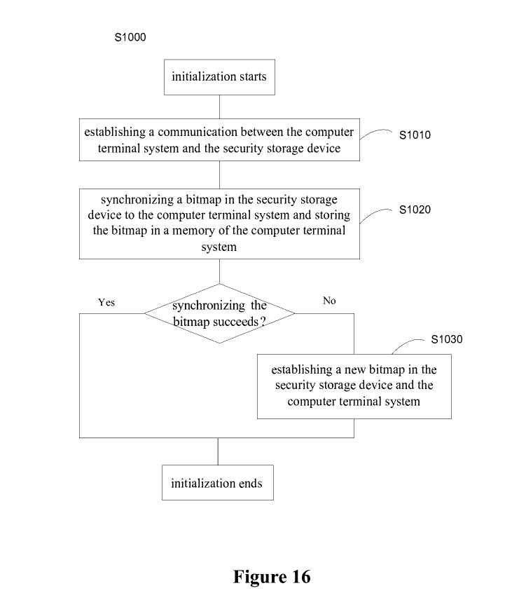

Referring to FIG. 16, in an embodiment, the initialization S1000 includes the following steps.

S1010, establishing a communication between the computer terminal system 200 and the security storage device 10.

S1020, synchronizing a bitmap in the security storage device 10 to the computer terminal system 200, for example, the bitmap is stored in a memory of the computer terminal system 200, where the bitmap is adapted to represent whether data in the local storage device has been dumped to the security storage device 10.

S1030, if the step S1020 fails, establishing and initializing another bitmap in the security storage device 10, and then synchronizing the another bitmap to the computer terminal system 200.

Wherein, in order to differ the bitmap in the computer terminal 200 and the another bitmap in the security storage device 10, without specified, the bitmap in the computer terminal 200 is called a bitmap or a first bitmap and the bitmap in the security storage device 10 is called a second bitmap below (the step S1030 may be concluded as establishing and initializing the second bitmap and then, synchronizing the second bitmap to the computer terminal system 200 and saving as the first bitmap).

Wherein, in the step 1020, if synchronizing the second bitmap in the security storage device 10 to the computer terminal system 200 is failed, it is known that this is a first connection between the computer terminal system 200 and the security storage device 10.

Wherein, the step 1030 may further include: mapping the local storage space in the computer terminal system 200 to the security storage device 10, where a mapping method/relationship is one-by-one mapping every sector (or other storage basic units) and establishing a bitmap.

In some embodiments, a bitmap from the local storage space to the storage device 10 may be established using other basic volumes as a unit. Detailed description for the bitmap is provided below in conjunction with figures.

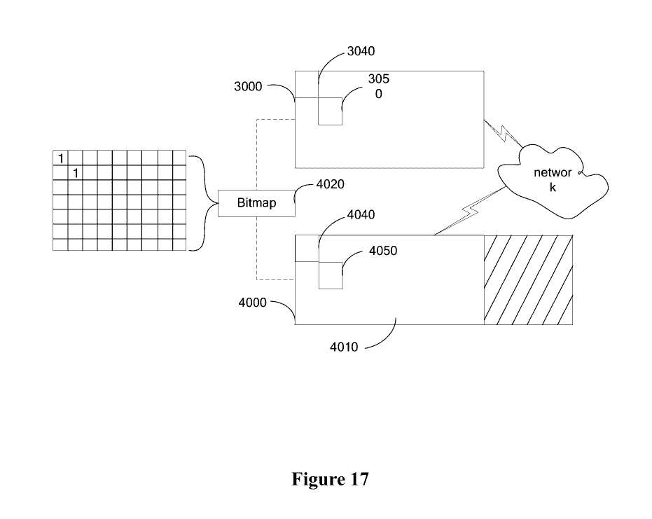

FIG. 17 schematically illustrates a bitmap according to an embodiment in the present disclosure. Referring to FIG. 17, it is presented that a storage medium 3000 in a local storage device (e.g., the hard disk 2062 as shown in FIG. 15) and a storage medium 4000 in the storage device 10 connected with the local storage device by a network.

(1) A procedure for establishing the bitmap is provided below.

A storage space 4010 have an identical volume to the storage medium 3000 is established in the storage medium 4000 so as to form a one-by-one mapping space. A bitmap 4020 is stored in the storage space 4010, where the bitmap 4020 is a bit map, where each bit represents a sector and data of the bit (e.g., 0 or 1) label/indicate whether a corresponding sector in the storage medium 3000 has been dumped to the storage space 4010 in the storage medium 4000, thus a bitmap can be called a dump table. The bitmap 4020 in the storage device 10 is established, and then is synchronized to the computer terminal system 200.

(2) A procedure for updating the bitmap is provided below.

For example, in the bitmap 4020, a dumped sector is labeled as 1 and an un-dumped sector is labeled as 0. In other embodiments, the dumped sector and the un-dumped sector may be labeled using other ways. When an application program or an operating system stores data (e.g., a file), a file system inside the operating system sets up a storage space with a certain volume on the storage medium 3000 of the local storage device, for example, a sector 3040 and a sector 3050. The storage space is allocated for the file, and a local file allocation table is re-written. When the file is dumped (that is, the data written in the sector 3040 and the sector 3050 is stored to the storage device 10), a sector 4040 and a sector 4050 with same locations are allocated in the storage medium 4000. The dumped data is stored in the sector 4040 and the sector 4050, and bits corresponding to the sector 4040 and the sector 4050 in the bitmap 4020 are labeled as 1.

In conjunction with FIG. 15, in an embodiment, the procedure for writing data S2000 further includes the following steps.

S2010, the application layer 202 sends a writing request through a file system of the operating system kernel layer 203, or the operating system kernel layer 203 sends the writing request directly; or

the application layer 202 directly sends the writing request to the hardware mapping layer 204, or the operating system kernel layer 203 directly sends the writing request to the hardware mapping layer 204.

S2020, the operating system kernel layer 203 analyzes the writing request to acquire a hardware port instruction (namely, a hardware instruction) that is sent to the hardware mapping layer 204, where the hardware port instruction includes a writing location (e.g., a sector).

It is noticed that, if the step S2010 directly sends the writing request to the hardware mapping layer 204, the writing request is the hardware port instruction already.

S2030, the security layer 205 receives the hardware port instruction from the hardware mapping layer 204, and the writing location (namely, the sector) in the port instruction is changed to a corresponding storage address in the storage device 10, thus the first bitmap is updated. For example, a bit corresponding to the sector is changed to 1, which indicates the sector has been dumped. The security layer 205 sends the changed port instruction to the hardware layer 206.

After completing the procedure for writing data, the data is not stored in the computer terminal system 200, and the data has been re-directed to and stored in the security storage device 10.

It is noticed that, if an instruction for writing data to a local hard disk differs from an instruction for writing data to an external hard disk (e.g., a network disk), not only an address but also a storage instruction needs modification.

In another embodiment, the procedure for writing data S2000 may further include:

S2040, synchronizing the first bitmap to the storage device 10 and storing as the second bitmap, so as to ensure that the first bitmap in the computer terminal system 200 and the second bitmap in the storage device are identical in real time.

In some embodiments, for purpose of conserving system resources, S2040 may be performed prior to shutdown of the computer terminal system 200.

In conjunction with FIG. 15, in an embodiment, the procedure for reading data S3000 further includes the following steps.

S3010, a second bitmap in the storage device 10 is synchronized to the computer terminal system 200 and then stored as a first bitmap.

S3020, the application layer 202 sends a reading request through a file system of the operating system kernel layer 203, or the operating system kernel layer 203 sends the reading request directly; or

the application layer 202 directly sends the reading request to the hardware mapping layer 204, or the operating system kernel layer 203 directly sends the reading request to the hardware mapping layer 204.

S3030, the operating system kernel layer 203 analyzes the writing request so as to acquire a hardware port instruction that is sent to the hardware mapping layer 204, where the hardware port instruction includes a reading location (e.g., a sector).

S3040, the security layer 205 receives the hardware port instruction (e.g., a data reading instruction) from the hardware mapping layer 204, and a reading address (namely, a source address) in the data reading instruction is acquired. The first bitmap is retrieved, and if a bit in the first bitmap shows that the reading address is labeled as a dumped address (that is, the data store in the address has been dumped), the reading address in the port instruction is changed by the security layer 205 to a corresponding storage address in the storage device 10; and the security layer 205 sends the changed port instruction to the hardware layer 206.

The embodiment has advantages: the procedure for reading data does not affect a current operating mode of a user and realize reading dumped data in a security storage device (namely, the storage device 10).

In the step S3010, synchronizing the second bitmap in the storage device 10 to local, which is performed for ensuring consistence between the data in the security storage device and the local data after rebooting the computer terminal system 200.

The ordinarily skilled in the art appreciates that which step or steps of the procedures for writing data, reading data and initialization is performed can be determined based on practical requirements.

### Data Security Access Method

Based on the procedures for writing and reading data, a data security storage and reading method is provided below.

The ordinarily skilled in the art appreciates that describing the procedures for writing and reading data in conjunction with FIG. 15 is for readers' convenience, which impose no limitation. In other embodiments, each step described can be performed on an appropriate layer of a computing device.

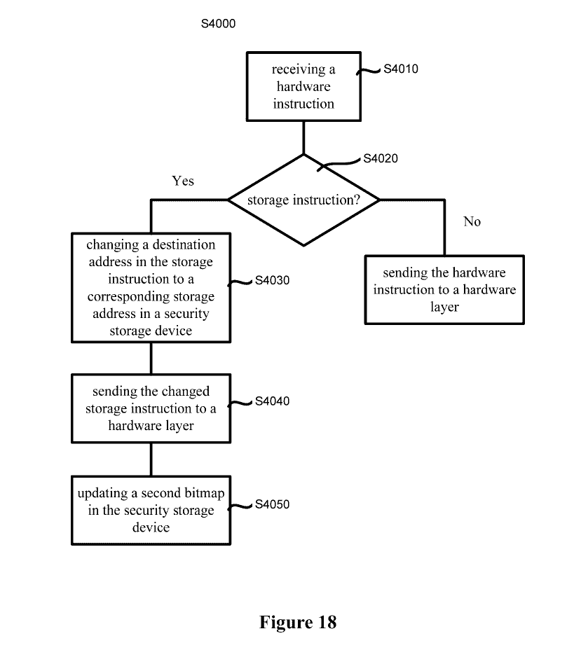

In an embodiment, a data security storage method S4000 is provided. Referring to FIG. 18, the method S4000 includes the following steps.

S4010, receiving a hardware instruction.

S4020, analyzing the hardware instruction and determining whether the hardware instruction is a storage instruction.

S4030, if the hardware instruction is a storage instruction, changing a destination address in the storage instruction to a corresponding storage address in a security storage device; and

S4040, sending the changed storage instruction to a hardware layer.

In an embodiment, in the step S4010, the hardware instruction is from a hardware mapping layer. Receiving the hardware instruction from the hardware mapping layer can fully (100%) screen all hardware instructions (e.g., interface instructions) sent to a processor such as a CPU, etc.

The operating system running on a computer terminal is Windows operating system, and in Windows, the hardware mapping layer 204 as shown in FIG. 15 is a

Hardware Abstract Layer (HAL). In other embodiments, the operating system running on the computer terminal may be other operating systems such as Linux, UNIX or other embedded operating systems, and the hardware mapping layer is a corresponding layer in Linux, UNIX or other embedded operating systems.

In the step S4010 that, in conjunction with the method for reconstructing an instruction in run time, receiving the hardware instruction may include: acquiring the hardware instruction using the method for reconstructing an instruction in run time (e.g., S101 to S105). In other words, when acquiring the hardware instruction using the method for reconstructing an instruction in run time, the storage instruction is processed (e.g., the similar method such as S404, S504 or S604). Using the method for reconstructing an instruction in run time, not only a computed final result can be re-directed to and stored in the security storage device, but also an intermediate step in computation (including an intermediate step generated by the operating system) can be entirely re-directed to and stored in the security storage device. Thus, in this way, a terminal computing device is incomplete, and further, due to incompletion of the terminal computing device, a goal that information divulgement is prevented is realized.

Furthermore, in the steps S4010 and S4020, there are various instruction analysis mechanisms within the terminal computing device to deal with different types of CPU instruction, such as an x86 instruction, an ARM instruction, an MIPS instruction, etc.

In another embodiment, after the step S4030, the method further includes: S4050, updating a first bitmap by labeling a bit corresponding to a destination address (e.g., a sector) in the first bitmap as a dumped mark, such as “1” and synchronizing an updated first bitmap to the security storage device, where the updated first bitmap is stored as a second bitmap.

In this embodiment, the dump operation is completely transparent to upper layers and a user, which does not affect the work flow of current computer operation or application system.

The method provided in this embodiment can not only be used in a computer terminal system, but also be used in any computing devices or intelligent terminals that include an application layer, an operating system kernel layer and a hardware layer, which realizes an instruction-level storage redirection in real time (namely, the storage relocation or redirection based on a hardware storage instruction.

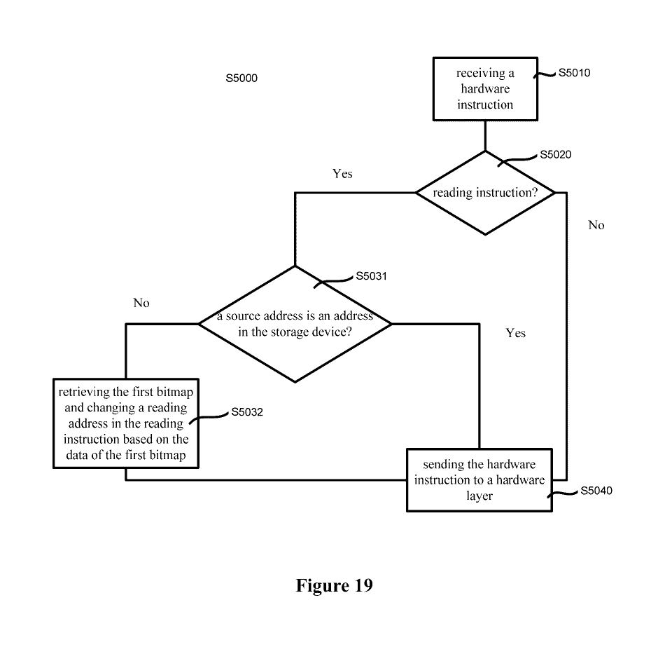

In an embodiment, a data security reading method S5000 is provided. Referring to FIG. 19, the method S5000 includes the following steps.

S5010, receiving a hardware instruction.

S5020, analyzing the hardware instruction and determining whether the hardware instruction is a reading instruction.

S5030, if the hardware instruction is a reading instruction, acquiring a source address (a reading address) in the reading instruction, and retrieving a first bitmap so as to change the reading address in the reading instruction based on the data of the first bitmap, so that reading both dumped data and un-dumped data is realized; and

S5040, sending the changed hardware instruction to a hardware layer.

In another embodiment, before the step S5010, the method may further include: synchronizing a second bitmap in a storage device to a computer terminal system and saving the second bitmap as a first bitmap.

In another embodiment, in the step S5010, the hardware instruction is from a hardware mapping layer.

In another embodiment, for the step S5010 that, in conjunction with the method for reconstructing an instruction in run time, receiving the hardware instruction may include: acquiring the hardware instruction using the method for reconstructing an instruction in run time (e.g., S101 to S105). In other words, when the hardware instruction using the method for reconstructing an instruction in run time is acquired, the reading instruction is processed.

In another embodiment, in the step S5020, if the hardware instruction is not a reading instruction, the hardware instruction is directly sent to the hardware layer for execution.

In another embodiment, the step S5030 may further include the following steps.

S5031, if the hardware instruction is a reading instruction, acquiring the source address in the reading instruction and determining whether the source address is in the storage device.

S5032, if the source address is not in the storage device, retrieving the first bitmap and changing a reading address in the reading instruction based on the data of the first bitmap.

Specifically, in step S5031, if the source address already is an address of the storage device, a computing device (e.g., the security layer 205 as shown in FIG. 15) is not required to retrieve the first bitmap but directly sends the hardware instruction to the hardware layer for execution.

In another embodiment, in order to save network resources, the security storage device 10 may be shared among multiple terminal systems.

Combination of the data security reading and storage method and the method for reconstructing an instruction is mentioned for several times hereinbefore, and for readers' convenience, the detailed embodiments are provide below.

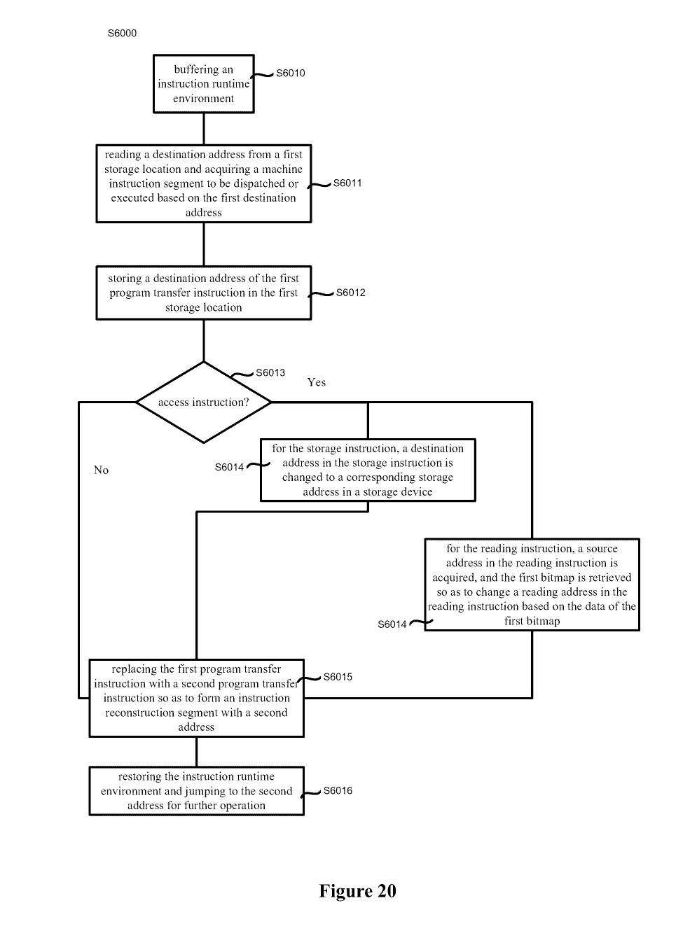

In an embodiment, a data security access method S6000 is provided. Referring to FIG. 20, the method S6000 includes the following steps.

S6010, buffering an instruction runtime environment.

S6011, reading a destination address from a first storage location and acquiring a machine instruction segment to be dispatched or executed based on the destination address, where a last instruction in the machine instruction segment to be dispatched is a first program transfer instruction (e.g., a jump instruction).

S6012, storing a destination address of the first program transfer instruction in the first storage location.

S6013, analyzing each instruction in the machine instruction segment to be dispatched and determining whether the instruction is an access instruction.

S6014, if an instruction is an access instruction (e.g., a storage instruction and a reading instruction), there are two cases.

(1) For the storage instruction, a destination address in the storage instruction is changed to a corresponding storage address in a storage device (namely, a security storage device) and a first bitmap is changed.

(2) For the reading instruction, a source address in the reading instruction is acquired, and the first bitmap is retrieved so as to change a reading address in the reading instruction based on the data of the first bitmap.

If an instruction for writing data to a local hard disk differs from an instruction for writing data to a network hard disk or an instruction for reading data from the local hard disk differs from an instruction for reading data from the network hard disk, not only an address but also a storage or reading instruction requires modification correspondingly.

S6015, replacing the first program transfer instruction with a second program transfer instruction so as to form an instruction reconstruction segment with a second address, where the second program transfer instruction points to an entrance address of an instruction reconstruction platform.

S6016, restoring the instruction runtime environment and jumping to the second address for further operation.

The ordinarily skilled in the art appreciates that the embodiments are provided for exemplary description, which impose no limitation to combination approach of the data security reading method, the data security storage method and the method for reconstructing an instruction. The aforementioned embodiments of the data security reading method, the data security storage method and the method for reconstructing an instruction can be combined according to various practical requirements.

### Data Security Transmission Method

Storage and reading generally aim to data exchange between local storage devices, and transmission generally aims to data exchange between network devices.

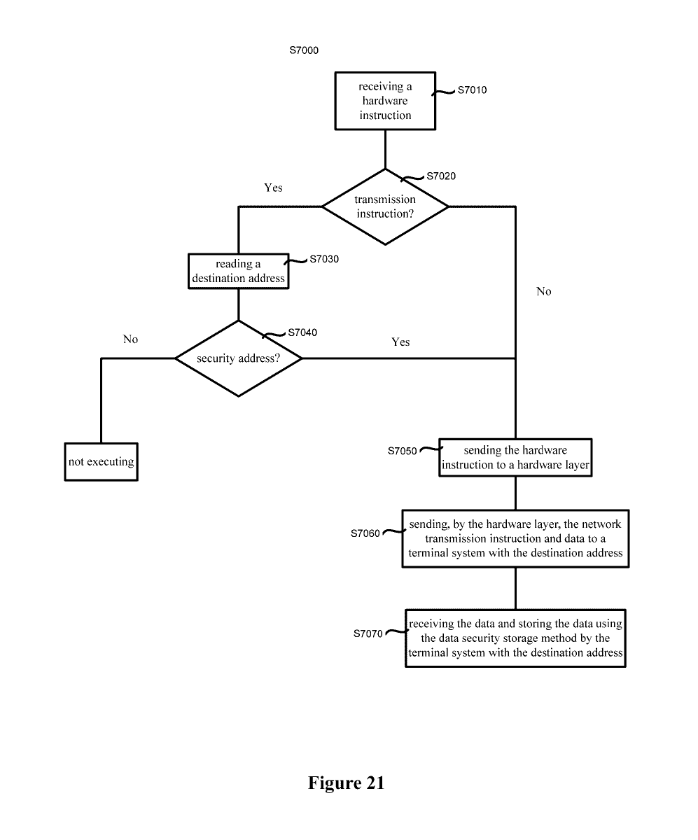

Referring to FIG. 21, in an embodiment, a data security access method S7000 is provided, which includes the following steps.

S7010, receiving a hardware instruction (e.g., form a hardware mapping layer).

S7020, analyzing the hardware instruction and determining whether the hardware instruction is a network transmission instruction.

S7030, if the hardware instruction is a network transmission instruction, reading a destination address.

S7040, determining whether the destination address is a security address.

S7050, if the destination address is a security address, sending the hardware instruction to a hardware layer and, if the destination address is not a security address, the hardware instruction is blocked.

S7060, sending, by the hardware layer, the network transmission instruction and data to a terminal system with the destination address.

S7070, receiving the data and storing the data using the data security storage method (described in the aforementioned embodiment) by the terminal system with the destination address.

In another embodiment, in the step S7040 that determining whether the destination address is a security address is described below.

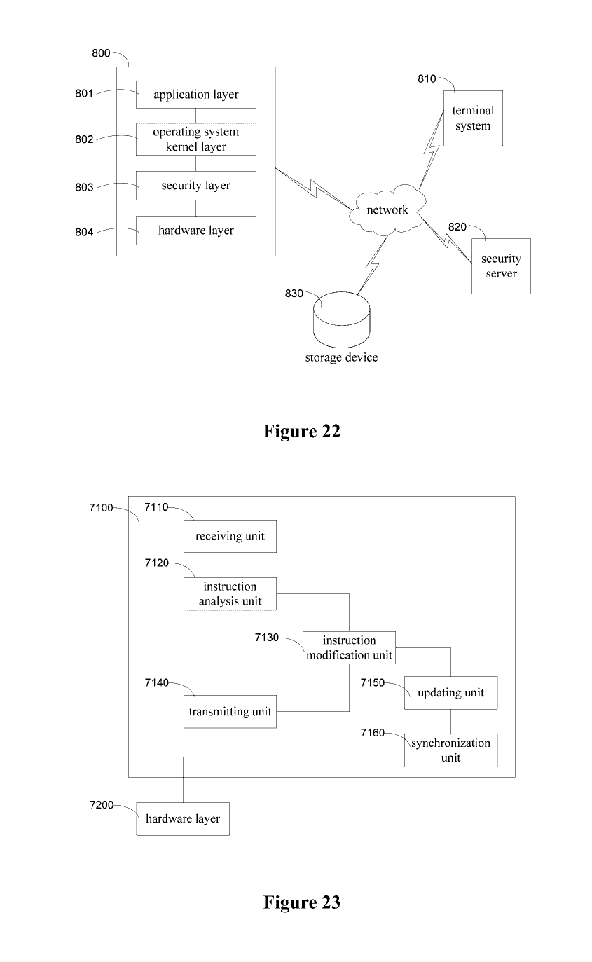

As shown in FIG. 22, a security server 820 is connected with terminal systems 800 and 810 through a network. When the data security transmission method provided in the embodiments of the present disclosure is configured in the terminal systems 800 and 810, the terminal system 800 or 810 has made a registration to the security server 820. A security address table is maintained in the security server 820, which records all registered terminal systems.

When the security address table is changed, the security server 820 automatically sends the changed security address table to each terminal. The architecture of the terminal system 800 includes: an application layer 801, an operating system kernel layer 802, a security layer 803 and a hardware layer 804; where the security layer 803 is responsible for maintaining the security address table.

The security layer 803 determines whether a destination address is a security address by determining whether the destination address is in the security address table. That is, in the step S7040, if a destination address is listed in the security address table, the destination address is a security address.

Using the data security transmission method, even if the Trojan virus or the malicious tool acquires confidential information, they are not capable of transmitting the acquired information.

Although the embodiments of the method provided in the present disclosure are described within a computer terminal system, any electronic equipment that can provide file or data editing, saving or transmitting operations, such as a handheld terminal and an intelligent terminal, can be a terminal system to apply the data security access and transmission method provided in the present disclosure.

### Data Security Access Device (Including Storage And Reading Device)

Corresponding to the data security storage method, in an embodiment, a data security storage device is provided.

It is noticed that, for avoiding confusion, in the present disclosure: (1) a data security storage device refers to a device for realizing data security storage method in a hardware form; (2) a security storage device refers to a storage substance adapted to dump information or data, such as a disk, etc.

Referring to FIG. 23, a data safety storage device 7100 includes: a receiving unit 7110, an instruction analysis unit 7120, an instruction modification unit 7130, and a transmitting unit 7140. Wherein, the receiving unit 7110 is coupled with the instruction analysis unit 7120. The instruction analysis unit 7120 is also coupled with the instruction modification unit 7130 and the transmitting unit 7140 respectively. And, the transmitting unit 7140 is also coupled with the instruction modification unit 7130.

Wherein, the receiving unit 7110 is adapted to receive a hardware instruction, and the hardware instruction may be from a hardware mapping layer.

Wherein, the instruction analysis unit 7120 is adapted to analyze the hardware instruction and determine whether the hardware instruction is a storage instruction. If the hardware instruction is a storage instruction, the instruction analysis unit 7120 is further adapted to send the hardware instruction to the instruction modification unit 7130. If the hardware instruction is not a storage instruction, the instruction analysis unit 7120 is further adapted to send the hardware instruction to the transmitting unit 7140.

Wherein, the instruction modification unit 7130 is adapted to change a destination address in the storage instruction to a corresponding storage address in a security storage device and send the changed storage instruction to the transmitting unit 7140.

Wherein, the transmitting unit 7140 is adapted to send a received instruction to a hardware layer 7200.

Further, in another embodiment, the data security storage device may include:

an updating unit 7150 and a synchronization unit 7160, where the updating unit 7150 is coupled with the instruction modification unit 7130, and the synchronization unit 7160 is coupled with the updating unit 7150.

Wherein, the updating unit 7150 is adapted to update a bit corresponding to the destination address in a bitmap after the instruction modification unit 7130 changes the storage instruction. In this embodiment, a bit corresponding to a sector with the destination address of the storage instruction is labeled as “1” so as to represent that the data stored in the sector has been dumped.

Wherein, the synchronization unit 7160 is adapted to establish a communication between a computer terminal system and the security storage device, and to perform a synchronization operation on the bitmap between the computer terminal system and the security storage device.

Specifically, when the computer terminal system is booted, the synchronization unit 7160 establishes the communication between the computer terminal system and the security storage device, synchronizes a second bitmap of the security storage device to the computer terminal system and saves the second bitmap as a first bitmap.

If it is failed to synchronize the second bitmap in the security storage device to the computer terminal system, it means that this is a first connection and communication between the computer terminal system and the security storage device. Then, the synchronization unit 7160 maps a local storage space of the computer terminal system to the security storage device and establishes the first bitmap and the second bitmap. In this embodiment, the second bitmap on the security storage device is established firstly. Next, the second bitmap is synchronized to the computer terminal system and saved as the first bitmap.

When the updating unit 7150 updates the bit corresponding to the destination address in the first bitmap, the synchronization unit 7160 sends an updated first bitmap to the security storage device, which is then saved as the second bitmap.

No limitation is imposed to the security storage device, the security storage device may be a remote storage device or a local storage device, where the remote storage device may serve for a stand-alone computing device or be shared among multiple computing devices.

In an embodiment, the hardware instruction may be a hardware port I/O instruction.

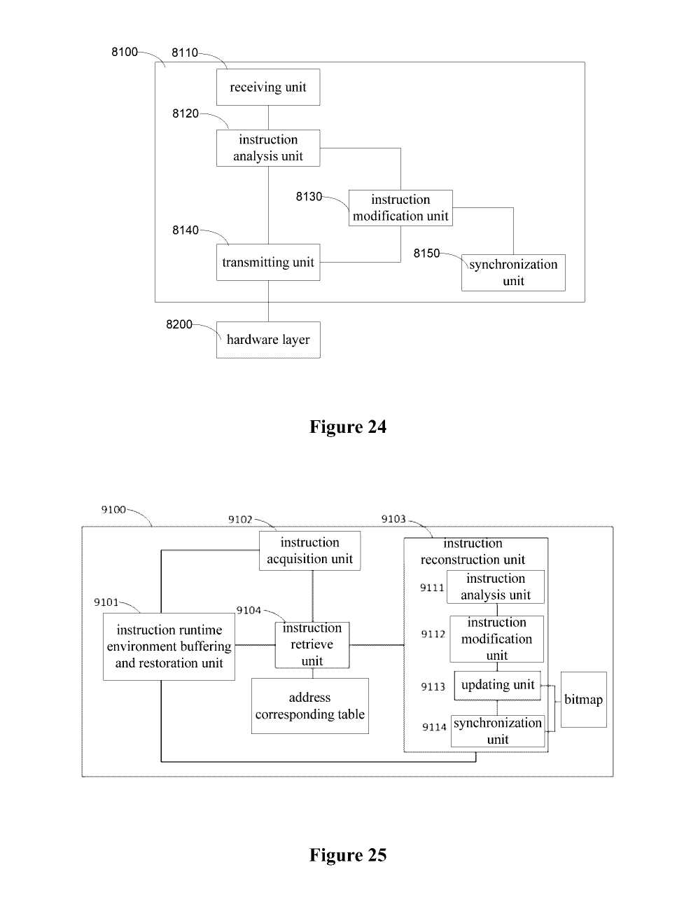

Corresponding to the data security reading method, in an embodiment, a data security reading device 8100 is provided. Referring to FIG. 24, the data security reading device 8100 includes:

a receiving unit 8110, an instruction analysis unit 8120, an instruction modification unit 8130 and a transmitting unit 8140. Wherein, the receiving unit 8110 is coupled with the instruction analysis unit 8120. The instruction analysis unit 8120 is also coupled with the instruction modification unit 8130 and the transmitting unit 8140 respectively. And, the instruction modification unit 8130 is also coupled with the transmitting unit 8140. Wherein, the transmitting unit 8140 is also coupled with a hardware layer 8200.

Wherein, the receiving unit 8110 is adapted to receive a hardware instruction, and the hardware instruction is from the hardware mapping layer in this embodiment.

Wherein, the instruction analysis unit 8120 is adapted to analyze the hardware instruction and determine whether the hardware instruction is a reading instruction. If the hardware instruction is a reading instruction, the instruction analysis unit 8120 is further adapted to acquire a source address of the reading instruction and determine whether the source address is an address in a security storage device.

If the hardware instruction is not a reading instruction or the source address is an address on the security storage device, the instruction analysis unit 8120 is adapted to send the hardware instruction to the transmitting unit 8140.

If the source address is not an address on the security storage device, the instruction modification unit 8130 is adapted to retrieve a bitmap and change a reading address of the reading instruction according to the data of the bitmap.

Same as the bitmap in the aforementioned embodiments, the bitmap in this embodiment is also adapted to represent whether the data with a local storage address is dumped to the security storage device, thus no tautology is provided. An example is given that the instruction modification unit 8130 is adapted to find a bit corresponding to a sector with the source address in a first bitmap. If the bit data is 1, it means that data dump has been performed. If the bit data is 0 or NULL, it means that data dump is not performed. If data dump has been performed, the instruction modification unit 8130 is adapted to change the source address (the reading address) to a corresponding data dump address and send the changed hardware instruction to the transmitting unit 8140.

Further, in another embodiment, the data security reading device may also include a synchronization unit 8150, which is coupled with the instruction modification unit 8130.

The synchronization unit 8150 is adapted to establish a communication between a computer terminal system and the security storage device and synchronize the bitmap between the computer terminal system and the security storage device. Specifically, when the computer terminal system is booted, the synchronization unit 8150 is adapted to establish the communication between the computer terminal system and the security storage device, and synchronizes a second bitmap of the security storage device to the computer terminal system, which is saved as a first bitmap and to be used by the instruction modification unit 8130.

In this embodiment, the security storage device is a remote storage device which may be shared among multiple computer terminal systems. In some embodiments of the present disclosure, the security storage device may be a local storage device.

In another embodiment, the data security storage device and data security reading device can be integrated into a device, where an instruction analysis and an instruction modification unit are adapted to not only process a storage instruction but also a reading instruction, and the detailed embodiments are provided below.

In another embodiment, a data security storage and reading device 9100 is provided. Referring to FIG. 25, the data security storage and reading device (namely, a data security access device) 9100 includes the following units.

An instruction runtime environment buffering and restoration unit 9101, which is adapted to buffer and restore an instruction runtime environment.

An instruction acquisition unit 9102 that is adapted to acquire an address of a next instruction to be executed, where the address of the next instruction to be executed is a first address. The instruction acquisition unit 9102 is further adapted to acquire a machine instruction segment to be dispatched or executed based on the first address, where a last instruction in the machine instruction segment to be dispatched is a first program transfer instruction. The method for acquiring the machine instruction segment to be dispatched has been described in detail hereinbefore, thus no tautology is provided.

An instruction retrieve unit 9104, that is adapted to retrieve an address corresponding table using the first address.

If a corresponding record is found, the instruction retrieve unit 9104 is adapted to call the instruction runtime environment buffering and restoration unit 9101 for restoring the buffered instruction runtime environment and jumping to a found address for further operation (the current reconstruction operation is completed).

If no corresponding record is found, an instruction reconstruction unit 9103 is adapted to perform a reconstruction operation.

Wherein, the address corresponding table is adapted to represent whether an instruction segment to be dispatched to which the first address points includes a stored instruction reconstruction segment. Wherein, the address corresponding table may include data such as an address pair.

Wherein, the instruction reconstruction unit 9103 further includes the following units.

An instruction analysis unit 9111, which combines the instruction analysis unit 7120 and the instruction analysis unit 8120, is adapted to analyze the hardware instruction and determine whether a hardware instruction in the machine instruction segment to be dispatched or executed is a storage instruction or a reading instruction.

If the instruction analysis unit 9111 finds a storage or reading instruction, there are two cases that:

(1) for a storage instruction, an instruction modification unit 9112 is adapted to change a destination address in the storage instruction to a corresponding storage address in a security storage device;

(2) for a reading instruction, the instruction modification unit 9112 is adapted to retrieve a bitmap so as to change a reading address in the reading instruction based on the data of the bitmap.

An updating unit 9113 is adapted to update a bit that corresponds to the destination address in the bitmap after the instruction modification unit 9112 changes the storage instruction so as to represent that local data has been dumped.

And, a synchronization unit 9114 is adapted to establish a communication between a computer terminal system and the security storage device and perform synchronization operation to the bitmap between the computer terminal system and the security storage device.

After operations of the instruction analysis unit 9111, the instruction modification unit 9112, the updating unit 9113 and the synchronization unit 9114 are completed, the instruction reconstruction unit 9103 is further adapted to replace the first program transfer instruction with a push instruction that records an address of the first program transfer instruction and a number of operations, and further adapted to insert a second program transfer instruction after the push instruction so as to form an instruction reconstruction segment with a second address, where the second program transfer instruction points to an entrance address of the device 9100. Moreover, the instruction reconstruction unit 9103 is further adapted to establish a record in the address corresponding table using the first address and the second address of the instruction reconstruction segment.

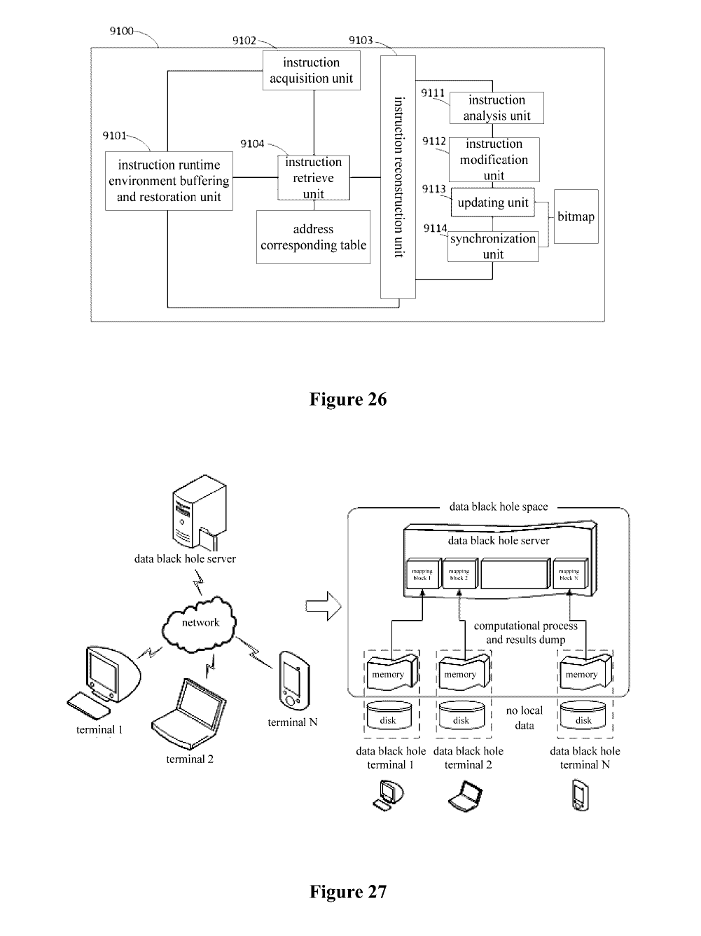

In an embodiment, referring to FIG. 26, the instruction reconstruction unit 9103, the instruction analysis unit 9111, the instruction modification unit 9112, the updating unit 9113 and the synchronization unit 9114 are parallel units in a layer.

Further referring to FIG. 25, after an instruction reconstruction segment is acquired by the instruction reconstruction unit 9103, the instruction reconstruction unit 9103 is adapted to call the instruction runtime environment buffering and restoration unit 9101 for restoring a buffered instruction runtime environment and jumping to an address of the instruction reconstruction segment for further operation (the current reconstruction operation is completed).

The ordinarily skilled in the art appreciates that the embodiments are provided for exemplary description, which impose no limitation to combination of the data security reading device, the data security storage device and the device for reconstructing an instruction. The aforementioned embodiments of the data security reading device, the data security storage device and the device for reconstructing an instruction can be combined according to various practical requirements.

Furthermore, the data security storage method and device can be integrated with the cloud technology, so as to ensure data security inside the cloud and improve application and popularity of the cloud computing. The detailed embodiments are provided below.

The ordinarily skilled in the art appreciates that the aforementioned method used in a security layer may also be used in various layers from an operating system kernel layer to a hardware layer. The location for realizing the functionality is not apart from the spirit and scope of the present disclosure.

The data security storage method and device provided in the present disclosure are described in detail in the aforementioned embodiments. Compared with a conventional art, the method and device have the following advantages:

(1) the data security storage method achieves an instruction level data dump which is a full data dump, and achieves data security storage during the full operating time of a computer terminal system based on the full data dump; on the one hand, even if the Trojan virus or the malicious tool acquires confidential information, they are capable of storing the acquired data, which assure that data is always in a security zone or under control; on the other hand, no confidential information or data is stored locally, which prevents a confidential staff from active or passive divulgement;

(2) By receiving hardware instructions from a hardware mapping layer, instructions can be 100% screened, which further improves data security.

The data security reading method and device provided in the present disclosure are described in detail in the aforementioned embodiments. Compared with a conventional art, the method and device has the following advantages:

(1) together with the data security storage method, the data security reading method ensures that all data are in security zone under control, and after data security storage (dump), the dumped data can be read; and since no confidential information or data is stored locally, it prevents a confidential staff from active or passive divulgement;

(2) when the security storage device is a remote storage device, it may be shared among multiple terminals, which improves space utilization of the security storage device.

### Data Black Hole Processing Method

Definition: (1) data black hole system: a system for storing intermediate data and operation results generated during operation of a computing device in a specific storage location and ensuring the computing device operates properly;

the data black hole system breaks completeness of the computing system and realizes a data security system without data divulgement even though a piece of malicious code or a confidential staff has a highest data authority by breaking completeness of the computing system.

(2) data black hole terminal: a computing device with the data black hole system (e.g., a computer terminal), where the data black hole terminal stores the intermediate data and the operating results generated during operation of the data black hole terminal in the specific storage location.

(3) redirection: a processing method that, when a persistence operation is performed to the intermediate data and the operating results generated during operation of a computer based on a computer operating requirement, under a circumstance that no modification is made to any logic and code of the computer, a persisted location is directed to the specific storage location.

(4) data writing: an operation for data persistence.

(5) data black hole space: definition is provided below.

(6) black hole storage partition: definition is provided below.

In an embodiment, a procedure A10 for improving data security is provided, where the procedure A10 includes the following steps.

A11, establishing a data black hole space for a user, which includes two modes (either of them may be performed).

First, A111 on-premise mode includes: the black hole terminal establishes a data storage partition in a local data storage device, where the data storage partition is a destination partition to which terminal data is re-directed, where the data storage partition is called a black hole storage partition.

A corresponding relationship between the data storage partition and a user may be that one data storage partition corresponds to multiple users using the computer (or local users), and may also be that multiple data storage partitions correspond to multiple users using the computer (or local users).

Only the data black hole system is allowed to visit the data storage partition, where the data storage partition may be inaccessible to an operating system and an application layer (e.g., application software) of a terminal computing system.

Second, A112 off-premise mode includes: establishing a data storage partition in a storage location on network, where the data storage partition is the destination partition to which the terminal data is re-directed.

A corresponding relationship between the data storage partition and a user using a network terminal may be a one-by-one corresponding relationship. Moreover, the data storage partition may correspond to a user using the computer (or a local user).

By configuring the on-premise mode or the off-premise mode, a data black hole space (abbreviated to a black hole space) is established.

A12, establishing a corresponding relationship between a user and a storage space for redirection.

When a terminal user first logs in the data black hole terminal, the data black hole terminal establishes a data storage partition corresponding to data black hole based on user information.

A13, re-directing all data persistence operations of the terminal computing device.

In an embodiment, after a user has logged in the data black hole terminal, the data black hole terminal determines existence of the black hole storage partition and establishes a corresponding relationship between the black hole storage partition and the user, where all data writing operations by the user on the computer (namely, the data black hole terminal) are re-directed to the black hole storage partition.

Implementing the aforementioned procedure A10, a black hole space and a user are correspondent. When a hacker duplicates, dumps, transmits and intercepts data after acquiring the data authority using malicious codes such as the system vulnerability, the system backdoor, the Trojan virus, etc. However, all data being transmitted to external devices, external ports, external users and external terminals, may be re-directed to the data black hole space (namely, the black hole space corresponding to the user), and the transmission may be completed inside the data black hole space (namely, the black hole space corresponding to the user).

Accordingly, all operations such as stealing data, intercepting data, transmitting data, etc., may be completed inside the data black hole space. If a confidential (namely, have the data authority) staff is trying to preserve, duplicate, transmit output data without permission, all data processing operations may be completed inside the data hole space (namely, the black hole space corresponding to the user), so that no divulgement will happen because of malicious manipulations.

In an embodiment, referring to FIG. 27, a computing device being capable of executing the procedure A10 is a data black hole server, where the data black hole server is connected/coupled with a computer terminal 1 (a terminal 1 as shown in the figure), a computer terminal 2 (a terminal 2 as shown in the figure) . . . and a computer terminal N (a terminal N as shown in the figure) through a network. The data black hole server configures a data black hole system to each terminal, and each terminal becomes a data black hole terminal (as shown in the figure that a data black hole terminal 1, a data black hole terminal 2, . . . and a data black hole terminal N).

Furthermore, a black hole storage partition (as shown in the figure, a mapping block 1, a mapping block 2, . . . and a mapping block N) is in the data black hole server (or a disk array server coupled with the data black hole server). Accordingly, a data black hole space includes the black hole partition of the black hole server and a memory for each data black hole terminal, so that both computational intermediate data and result data of the black hole server are stored in the black hole storage partition. The data black hole system breaks completeness of the computing system and realizes a data security system without data divulgement even though a piece of malicious code or a confidential staff has the highest data authority.

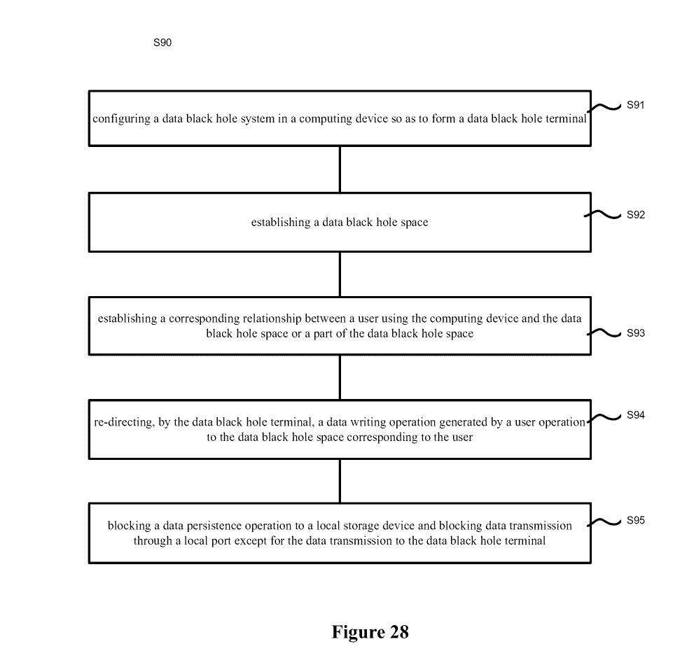

Based on the procedure A10, in an embodiment, a data black hole processing method S90 is provided. Referring to FIG. 28, the method S90 includes the following steps.

S91, configuring a data black hole system in a computing device (e.g., a computer, a handheld communication device, a smart terminal, etc.) so as to form a data black hole terminal.

S92, establishing a data black hole space, which includes:

(1) establishing a local data storage partition (called a black storage partition) in the computing device and a local memory; and/or

(2) establishing the data storage partition (called the black storage partition) in a storage location on network and a local memory.

S93, establishing a corresponding relationship between a user using the computing device and the data black hole space or a part of the data black hole space. For example, when a user logs in the data black hole terminal, a one-by-one mapping relationship is formed between the user and the data black hole space.

S94, re-directing, by the data black hole terminal, a data writing operation generated by a user operation to the data black hole space corresponding to the user. For example, a data writing operation is re-directed to a data black hole partition corresponding to the user.

S95, blocking a data persistence operation to a local storage device and blocking data transmission through a local port except for the data transmission to the data black hole terminal so as to ensure data entering the data black hole terminal or the data black hole space only exists in the data black hole space.

In another embodiment, the steps S91 and S92 that configuring the data black hole system and establishing the data black hole space for a user may be combined into one step.

In another embodiment, the step S93 may be only performed at a first time login, or performed at every time a user logs into the data black hole space.

In another embodiment, the steps S93 and S94 may be combined into one step.

Specifically, when a user performs a data writing operation, according to a predetermined corresponding way, the user's data writing operation is re-directed to the data black hole space corresponding to the user.

Wherein, the predetermined corresponding way may be a fixed correspondence. For example, each user in the black hole space corresponds to a certain volume of storage space. The predetermined corresponding way may be dynamic correspondence. For example, each user is corresponded to a storage space with a predetermined volume in the black hole space. If data stored by a user exceeds the predetermined volume, a storage space with a greater volume (e.g., double, 4 times or 8 times the predetermined volume, etc.) is allocated for the user. The ordinarily skilled in the art appreciates that the corresponding way and allocation way between a user and the storage space may be selected based on practical requirements.

In an embodiment, based the aforementioned procedure A10, after a user logs into a data black hole terminal, the data black hole terminal determines existence of a data black hole storage partition and establishes a corresponding relationship between a user and the data black hole storage partition. All of the user's data writing operations in a computer (the data black hole terminal) are re-directed to the data black hole storage partition. Moreover, all data reading operations read data in the data black hole storage partition or data in a local computer (or local data) based on a data version or a user choice.

Based on the aforementioned embodiments of the data security reading method(e.g., S5000) and the aforementioned embodiments of the data security reading device(e.g., the data security reading device 8100), in order to provide a functionality of user choice, modification may be made accordingly.

In an embodiment, a data security reading method S80 is provided, which includes the following steps.

S81, receiving a hardware instruction.

S82, analyzing the hardware instruction and determining whether the hardware instruction is a reading instruction.

S83, for the reading instruction, based on data of a bitmap, if data to be read by the reading instruction has been dumped,

providing an opportunity for selecting operating mode to a user, where the user may select reading data from a storage partition or reading data from a local computer (or reading local data).

Wherein, reading the data from the storage partition or reading the data from the local computer (or reading the local data) is based on the user selection. For example, a user selects reading data from the storage partition.

S84, sending the changed hardware instruction to a hardware layer.

Other aspects and steps of the data security reading method S80 may refer to the data security reading method S5000, thus no tautology is provided.

Similarly, this embodiment of the data security reading device may be changed accordingly. For example, the instruction modification unit 8130 in the data security reading device 8100 is changed for being adapted to perform the step S83, and other units may refer to the data security reading device 8100, thus no tautology is provided.

The skilled in the art (the ordinarily skilled in the art) appreciates that the data security storage method, the data security reading method and data security transmission method may be realized using software or hardware:

(1) if the methods are realized using software, corresponding steps of the method are stored in a computer readable medium in a form of software code so as to be a software product;

(2) if the methods are realized using hardware, corresponding steps of the method are programmed by hardware code (e.g., Verilog) and substantialized (through a procedure including physical design, placement and routing, tape-out, etc.) into a chip product (e.g., a processor).

Specifically, the ordinarily skilled in the art appreciates that the embodiments of the present disclosure can realize a system, a method or a computer program product. Therefore, the embodiments of the present disclosure may be implemented in a form of an entirely hardware-based, a form of an entirely software-based (including firmware, resident software, microcode, etc.), or a form of integrating both hardware and software, which may be called a circuit, a module or a system.

Furthermore, the embodiments of the present disclosure may employ a form of a computer program product realized in any physical mediums that express a piece of computer accessible program code.

Any combination of one or more available computers or computer readable medium may be applied. The available computers or the computer readable medium includes (but not limited to) a system, a device, an equipment or a transmission medium which may be electronic-based, magnetic-based, optical-based, electro-magnetic-based, infrared-based or semiconductor-based. Examples of the computer readable medium includes but not limited to: a portable computer magnetic disk electrically connected by one or more wires, a hard disk, a Random

Access Memory (RAM), a Read-Only Memory (ROM), an Erasable Programmable ROM (EPROM or a flash), an optical fiber, a Compact Disc Read-Only Memory (CD-ROM), an optical storage equipment, transmission medium supporting the Internet or the Ethernet, or a magnetic storage equipment.

It is noticed that the available computers or the computer readable medium may even include other appropriate medium such as a paper or a printable program, because a program can be processed by being captured electrically first and then edited, translated, etc. through optically scanning a paper or other mediums. If necessary, a processed program is then stored in a computer storage device. In the context of the present disclosure, the available computers or the computer readable medium may be any medium which can include a program, store a program, transmit a program or send a program, where the medium can be used by an instruction execution system, device, or equipment or used in collaboration with the instruction execution system, device, or equipment. The computer readable medium may include a transmitted data signal including a piece of computer readable program code, where the data signal may be in a baseband signal or a part of a carrier signal. The piece of computer readable program code may be transmitted through any appropriate medium, which includes but not limited to wireless, wire, optical fiber, Radio Frequency (RF), etc.

A piece of computer program code for performing operations in the present disclosure may be any combination of one or more programming languages that include object-oriented programming languages such as JAVA, Smalltalk, C++, etc., or conventional programming languages such as the C language or a similar programming language. The piece of program code may be fully executed in a user's computer, or partially executed in a user's computer serving as a stand-alone software packet, or partially executed in a user's computer and partially executed in a remote computer, or fully executed in a remote computer or a server. Under a circumstance that the piece of program code is executed in a remote computer, the remote computer may be connected to a user's computer through any types of network such as a Local Area Network (LAN) or a Wide Area Network (WAN) or a connection to an external computer (e.g., through the Internet provided by an Internet service provider).

Without departing from the spirit and scope of the present disclosure claims attached hereinafter, modification and improvement can be made to the aforementioned embodiments in the present disclosure. Accordingly, the embodiments in the present disclosure impose no limitation to the claimed scope of protection.

1. A data black hole processing method, comprising:
configuring a data black hole system in a computing device so as to form a data black hole terminal, wherein the data black hole system can store intermediate data and an operation result generated during operation of the computing device in a specific storage location, and ensure that the computing device runs normally;
establishing a data black hole space, wherein the data black hole space comprises a data storage partition established at a storage location on a network, wherein the data storage partition is adapted to be visited by the data black hole system but not by an operating system or software of an application layer;
establishing a corresponding relationship between a user using the computing device and the data black hole space or a part of the data black hole space;
re-directing a data writing operation generated by a user's operation at the data black hole terminal to the data black hole space corresponding to the user;
blocking a data persistence operation to a local storage device; and
blocking data output through a local port except for data output to the data black hole terminal so as to ensure data entering the data black hole terminal or the data black hole space only exists in the data black hole space.

2. The method according to claim 1, wherein configuring the data black hole system comprises configuring a data security storage method, which is adapted to re-direct a data writing operation generated by an operation of a user at the data black hole terminal to a data black hole space corresponding to the user, wherein the data security storage method comprises:
receiving a first hardware instruction;
if the first hardware instruction is a storage instruction, changing a destination address in the storage instruction to an address in the data black hole space corresponding to the user; and
sending the changed storage instruction to a hardware layer for execution.

3. The method according to claim 2, wherein configuring the data black hole system comprises configuring a data security reading method, which comprises:
receiving a second hardware instruction;
if the second hardware instruction is a reading instruction and data to be read by the reading instruction has been stored in the data black hole space, changing a source address in the reading instruction to an address in the data black hole space corresponding to the user; and
sending the changed reading instruction to the hardware layer for execution.

4. The method according to claim 2, wherein configuring the data black hole system comprises configuring a data security reading method, which comprises:
receiving a second hardware instruction;
if the second hardware instruction is a reading instruction and data to be read by the reading instruction has been stored in the data black hole space, providing the user with a choice that reading data in a local storage device or in the data black hole space;
reading the data in the local storage device or in the data black hole space based on the user's choice; and
sending, if reading the data in the data black hole space, the changed reading instruction to the hardware layer for execution and if reading the data in the local storage device, the reading instruction to the hardware layer for execution.

5. The method according to claim 4, wherein reading the data in the data black hole space comprises:
changing a source address in the reading instruction to an address in the data black hole space corresponding to the user.

6. The method according to claim 3, wherein receiving the hardware instruction comprises:
receiving the first and second hardware instruction from a hardware abstract layer.

7. The method according to claim 1, wherein configuring the data black hole system comprises configuring a data security storage method, which is adapted to re-direct a data writing operation generated by an operation of a user at the data black hole terminal to a data black hole space corresponding to the user, wherein the data security storage method comprises:
buffering a first instruction runtime environment, wherein the first instruction runtime environment comprises an address register, which is adapted to store an address of a next machine instruction to be executed, wherein the address of the next machine instruction to be executed is a first address;
acquiring a machine instruction segment to be dispatched, wherein a last instruction in the machine instruction segment to be dispatched is a first program transfer instruction;
analyzing each instruction in the machine instruction segment to be dispatched and, if there is a storage instruction in the machine instruction segment, changing a destination address in the storage instruction to a corresponding storage address in the data black hole space;
inserting, before the first program transfer instruction, a second program transfer instruction so as to form an instruction reconstruction segment with a second address, wherein the second program transfer instruction points to an entrance address of an instruction reconstruction platform;
changing the first address stored in the address register to the second address; and
restoring the first instruction runtime environment.

8. The method according to claim 1, wherein configuring the data black hole system comprises configuring a data security storage method, which is adapted to re-direct a data writing operation generated by an operation of a user at the data black hole terminal to a data black hole space corresponding to the user, wherein the data security storage method comprises:
buffering a first instruction runtime environment;
reading a destination address from a first storage location and acquiring a machine instruction segment to be dispatched based on the destination address, wherein a last instruction in the machine instruction segment to be dispatched is a first program transfer instruction;
storing a destination address of the first program transfer instruction in the first storage location;
analyzing each instruction in the machine instruction segment to be dispatched and, if there is a storage instruction in the machine instruction segment, changing a destination address in the storage instruction to a corresponding storage address in the data black hole space;
replacing the first program transfer instruction with a second program transfer instruction so as to form an instruction reconstruction segment with a second address, wherein the second program transfer instruction points to an entrance address of an instruction reconstruction platform; and
restoring the first instruction runtime environment and jumping to the second address for further operation.

9. The method according to claim 1, wherein configuring the data black hole system comprises configuring a data security storage method, which is adapted to re-direct a data writing operation generated by an operation of a user at the data black hole terminal to a data black hole space corresponding to the user, wherein the data security storage method comprises:
buffering a first instruction runtime environment;
acquiring an address and a parameter of a program transfer instruction stored in a stack;
computing an address of a next instruction to be executed based on the address and the parameter, wherein the address of the next instruction to be executed is a first address;
acquiring a machine instruction segment to be dispatched based on the first address, wherein a last instruction in the machine instruction segment to be dispatched is a first program transfer instruction;
analyzing each instruction in the machine instruction segment to be dispatched and, if there is a storage instruction in the machine instruction segment, changing a destination address in the storage instruction to a corresponding storage address in the data black hole space;
replacing the first program transfer instruction with a push instruction, wherein an address and a parameter of the first program transfer instruction are recorded in the push instruction;
adding a second program transfer instruction after the push instruction so as to form an instruction reconstruction segment with a second address, wherein the second program transfer instruction points to an entrance address of an instruction reconstruction platform; and
restoring the first instruction runtime environment and jumping to the second address for further operation.

10. The method according to claim 7, wherein configuring the data black hole system comprises configuring a data security reading method, which comprises:
buffering a second instruction runtime environment, wherein the second instruction runtime environment comprises an address register, which is adapted to store an address of a next machine instruction to be executed, wherein the address of the next machine instruction to be executed is the first address;
acquiring a machine instruction segment to be dispatched, wherein a last instruction in the machine instruction segment to be dispatched is the first program transfer instruction;
analyzing each instruction in the machine instruction segment to be dispatched and, if there is a reading machine instruction in the machine instruction segment and data to be read by the reading instruction has been stored in the data black hole space, changing a source address in the reading instruction to a corresponding storage address in the data black hole space;
inserting, before the first program transfer instruction, the second program transfer instruction so as to form an instruction reconstruction segment with the second address, wherein the second program transfer instruction points to an entrance address of an instruction reconstruction platform;
changing the first address stored in the address register to the second address; and
restoring the second instruction runtime environment.

11. The method according to claim 8, wherein configuring the data black hole system comprises configuring a data security reading method, which comprises:
buffering a second instruction runtime environment;
reading a destination address from the first storage location and acquiring a machine instruction segment to be dispatched based on the destination address, wherein a last instruction in the machine instruction segment to be dispatched is the first program transfer instruction;
storing a destination address of the first program transfer instruction in the first storage location;
analyzing each instruction in the machine instruction segment to be dispatched and, if there is a reading instruction in the machine instruction segment and data to be read by the reading instruction has been stored in the data black hole space, changing a source address in the reading instruction to a corresponding storage address in the data black hole space;
replacing the first program transfer instruction with the second program transfer instruction so as to form an instruction reconstruction segment with the second address, wherein the second program transfer instruction points to an entrance address of an instruction reconstruction platform; and
restoring the second instruction runtime environment and jumping to the second address for further operation.

12. The method according to claim 9, wherein configuring the data black hole system comprises configuring a data security reading method, which comprises:
buffering a second instruction runtime environment;
acquiring an address and a parameter of a program transfer instruction stored in a stack;
computing an address of a next instruction to be executed based on the address and the parameter, wherein the address of the next instruction to be executed is the first address;
acquiring a machine instruction segment to be dispatched based on the first address, wherein a last instruction in the machine instruction segment to be dispatched is the first program transfer instruction;
analyzing each instruction in the machine instruction segment to be dispatched and, if there is a reading instruction in the machine instruction segment and data to be read by the reading instruction has been stored in the data black hole space, changing a source address in the reading instruction to a corresponding storage address in the data black hole space;
replacing the first program transfer instruction with a push instruction, wherein an address and a parameter of the first program transfer instruction are recorded in the push instruction;
adding the second program transfer instruction after the push instruction so as to form an instruction reconstruction segment with the second address, wherein the second program transfer instruction points to an entrance address of an instruction reconstruction platform; and
restoring the second instruction runtime environment and jumping to the second address for further operation.

13. The method according to claim 1, wherein the data persistence operation comprises a data writing operation.

14. The method according to claim 7, wherein acquiring the machine instruction segment to be dispatched comprises:
reading an address of a machine instruction to be dispatched from the address register;
for finding a program transfer instruction, retrieving the machine instruction to which the address of the machine instruction points and other instructions following the machine instruction till first found of a program transfer instruction, which is called the first program transfer instruction, wherein the first program transfer instruction is adapted to change an order for executing machine instructions; and
forming the machine instruction segment to be dispatched including the first program transfer instruction and all machine instructions to be dispatched before the first program transfer instruction.

15. The method according to claim 7, wherein acquiring the machine instruction segment to be dispatched comprises:
reading an address of a machine instruction to be dispatched from the address register;
for finding a program transfer instruction, retrieving the machine instruction to which the address of the machine instruction points and other instructions following the machine instruction till a first program transfer instruction with a parameter address is found, which is called the first program transfer instruction, wherein the first program transfer instruction is adapted to change an order for executing machine instructions; and
forming the machine instruction segment to be dispatched including the first program transfer instruction and all machine instructions to be dispatched before the first program transfer instruction.

16. The method according to claim 4, wherein receiving the hardware instruction comprises:
receiving the first and second hardware instruction from a hardware abstract layer.

17. The method according to claim 8, wherein acquiring the machine instruction segment to be dispatched comprises:
reading an address of a machine instruction to be dispatched from the address register;
for finding a program transfer instruction, retrieving the machine instruction to which the address of the machine instruction points and other instructions following the machine instruction till first found of a program transfer instruction, which is called the first program transfer instruction, wherein the first program transfer instruction is adapted to change an order for executing machine instructions; and
forming the machine instruction segment to be dispatched including the first program transfer instruction and all machine instructions to be dispatched before the first program transfer instruction.

18. The method according to claim 9, wherein acquiring the machine instruction segment to be dispatched comprises:
reading an address of a machine instruction to be dispatched from the address register;
for finding a program transfer instruction, retrieving the machine instruction to which the address of the machine instruction points and other instructions following the machine instruction till first found of a program transfer instruction, which is called the first program transfer instruction, wherein the first program transfer instruction is adapted to change an order for executing machine instructions; and
forming the machine instruction segment to be dispatched including the first program transfer instruction and all machine instructions to be dispatched before the first program transfer instruction.

19. The method according to claim 8, wherein acquiring the machine instruction segment to be dispatched comprises:
reading an address of a machine instruction to be dispatched from the address register;
for finding a program transfer instruction, retrieving the machine instruction to which the address of the machine instruction points and other instructions following the machine instruction till a first program transfer instruction with a parameter address is found, which is called the first program transfer instruction, wherein the first program transfer instruction is adapted to change an order for executing machine instructions; and
forming the machine instruction segment to be dispatched including the first program transfer instruction and all machine instructions to be dispatched before the first program transfer instruction.

20. The method according to claim 9, wherein acquiring the machine instruction segment to be dispatched comprises:
reading an address of a machine instruction to be dispatched from the address register;
for finding a program transfer instruction, retrieving the machine instruction to which the address of the machine instruction points and other instructions following the machine instruction till a first program transfer instruction with a parameter address is found, which is called the first program transfer instruction, wherein the first program transfer instruction is adapted to change an order for executing machine instructions; and
forming the machine instruction segment to be dispatched including the first program transfer instruction and all machine instructions to be dispatched before the first program transfer instruction.
